(19) United States
(12) Patent Application Publication
(10) Pub. No.: US 2024/0221022 A1
(43) Pub. Date: Jul. 4, 2024

(54) METHODS AND SYSTEMS FOR PRIORITY OBJECT DISTRIBUTION

(71) Applicant: Loop Commerce, Inc., Stamford, CT (US)

(72) Inventor: Gabriel Saunkeah, Stamford, CT (US)

(21) Appl. No.: 18/392,156

(22) Filed: Dec. 21, 2023

Related U.S. Application Data
(60) Provisional application No. 63/476,395, filed on Dec. 21, 2022.

(51) Int. Cl. G06Q 30/0226; G06Q 30/0207

(52) U.S. Cl. CPC G06Q 30/0233; G06Q 30/0236

(57) ABSTRACT

Systems and methods for determining whether a user associated with a provider system qualifies to receive an option to redeem a reward. A gifting service system may assess user information and various other types of information using a reward offer algorithm to make the determination. When the user qualifies to receive the option to redeem a reward, the user may be provided with a redemption option Once the user selects the option, the gifting service system obtains various selections and items of information, and sends gift options to an user. The gifting service system interacts with the user to obtain various selections and items of information to facilitate delivery of the gift to the user or other entity.

### CROSS REFERENCE TO RELATED APPLICATIONS

The present application claims priority of U.S. Provisional Patent Application 63/476,395 filed Dec. 21, 2022, which is incorporated herein by reference in its entirety.

### FIELD

The present disclosure relates to systems and methods for providing priority object distribution based on algorithmic assessment of users.

### SUMMARY

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment”, one or more embodiments, or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a user interacts with a provider system, a determination is made as to whether the user qualifies to receive an option to redeem a reward, information is obtained from the user, and a gift is delivered in accordance with at least one embodiment;

FIG. 2 shows an illustrative example of an environment in which a user interacts with a provider system, a determination is made as to whether the user qualifies to receive an option to redeem a reward, information is obtained from the user, and a gift is delivered in accordance with at least one embodiment;

FIG. 3 shows an illustrative example of an environment in which a user interacts with a provider system, a determination is made as to whether the user qualifies to receive an option to redeem a reward, information is obtained from the user, and a gift is delivered in accordance with at least one embodiment;

FIG. 4 shows an illustrative example of an environment in which a user interacts with a provider system, a determination is made as to whether the user qualifies to receive an option to redeem a reward, information is obtained from the user, and a gift is delivered to regift recipient in accordance with at least one embodiment;

FIG. 5 shows an illustrative example of an environment in which a user interacts with a provider system, a determination is made as to whether the user qualifies to receive an option to redeem a reward, information is obtained from the user, and a donation is delivered to donation recipient in accordance with at least one embodiment;

FIG. 6 shows an illustrative example of a process for determining whether a user qualifies for the receipt of an option to redeem a reward in accordance with at least one embodiment;

FIG. 7 shows an illustrative example of a user interface element offering a best customer reward in accordance with at least one embodiment;

FIG. 8 shows an illustrative example of a user interface element offering a best customer reward within a user interface in accordance with at least one embodiment;

FIG. 9 shows an illustrative example of a user interface element offering a best customer reward within a user interface in accordance with at least one embodiment;

FIG. 10 shows an illustrative example of a user interface beginning a reward redemption process in accordance with at least one embodiment;

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Users often have relationships with providers that provide goods and/or services. Such users may interact with a certain provider by accessing a provider system (e.g., a website, a portal, mobile app, kiosk, etc.) associated with a provider. In some instances, the provider may wish to improve the chances of maintaining a relationship with the user, cause the user to have an improved opinion of the provider, incentivize the user to interact more with the provider (e.g., purchase more goods and/or services), etc. One way to achieve such goals is to provide the user with rewards for being a certain type of user (e.g., a “best customer”). User's can be authenticated by a provider system by various processes, including passwords, biometric data, trusted device authentication, two-way authentication, personal question and answer data, or other such operations for a user to be established as an authenticated user of a provider system.

Embodiments disclosed herein may provide a framework for dynamically, in real-determining whether to provide a user with an option to redeem a gift, and for determining what one or more gift options to present to a user presented with such an option. Through this framework, details about the user may be obtained. Examples of such details may include, but are not limited to: the length of time the user has been a customer of a provider, certain actions taken by the user (e.g., paying a bill, spending a certain amount, etc.), customer demographic information (e.g., region of residence, age, marital status, etc.), information derived from a user profile, data range of an action (e.g., made a purchase over a certain amount in a certain time window), whether or not an external factor exists (e.g., near a holiday), etc. Such user details and characteristics (e.g., user information) may be used, for example, to determine whether the user should be offered a reward (e.g., a “best customer” reward). The user details may be obtained in real-time as a user interacts with a provider system for which the determinations are being made and/or may be derived from historical information obtained about a user.

In one or more embodiments, user information may, in whole or in part, be provided to a reward offer algorithm, which may dynamically analyze the user information in real time to determine whether the user should be offered a reward. Such information may be further analyzed dynamically in real time to determine, for those users to which a reward was offered, gift options to be presented to the user. In one or more embodiments, the gift options may be determined by a gift options algorithm using the user information and product information associated with a provider to determine the gift options to be presented to the user.

In one or more embodiments, when a determination is made to present a user with an option to redeem a gift, the option may be presented in any of a variety of ways, including, but not limited to, as an embedded user interface element (e.g., a button) presented on a user interface provided to the user by a provider system, through a separate communication channel (e.g., email, text, messenger service, etc.), etc. In one or more embodiments, the option to redeem a gift is determined by a gifting service system based on user information provided by a provider system to the gifting service system. In other embodiments, the option to redeem a gift is determined by the provider system. In one or more embodiments, the provider system engages the gifting service system to present the option to the user. The provider system may engage the gifting service system using any suitable technique. As an example, the gifting service system may provide an application programming interface (API) that may be engaged by a provider system to request that an option to redeem a gift be presented to a user, which may, for example, cause the gifting service system to provide an embeddable link or other user interface element to present to the user via a user interface of the provider system, in an email, etc.

In one or more embodiments, if a consumer elects to redeem a gift, various gift options and requests for information may be presented to the user, such as contact information of the user, various selections and/or customizations related to the gift, etc. The gift may then be delivered to the user. In one or more embodiments, be allowing a provider associated with a provider system to engage with a gifting service system to determine whether to present an option to redeem a gift to users having certain characteristics, a provider may improve a relationship with users having the requisite characteristics, improve user engagement with the provider, encourage the user to conduct more transactions with the provider, etc.

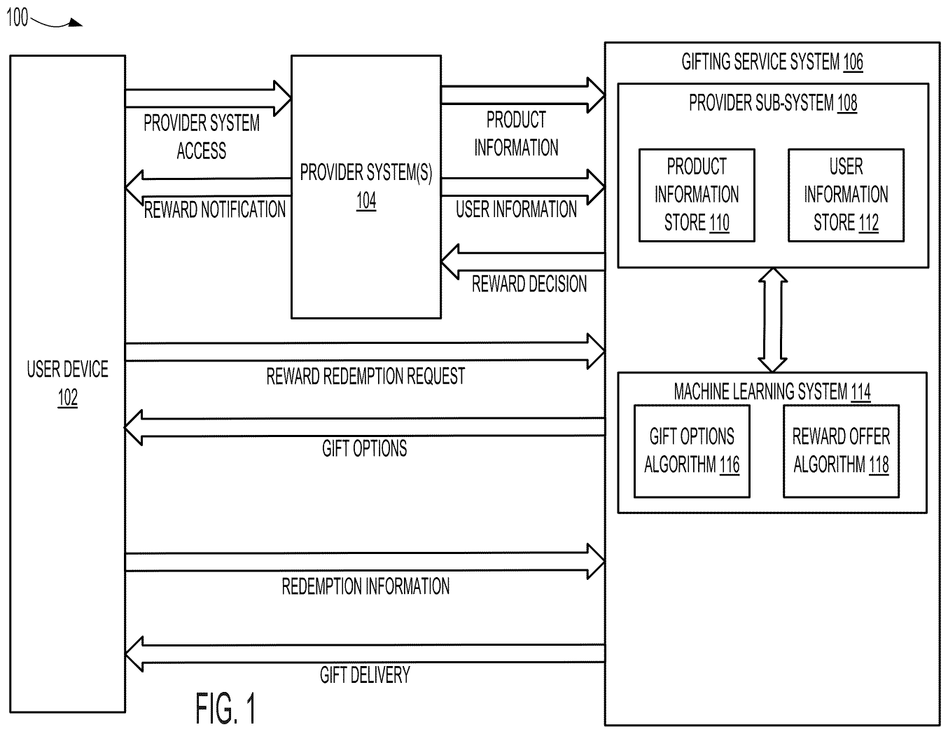

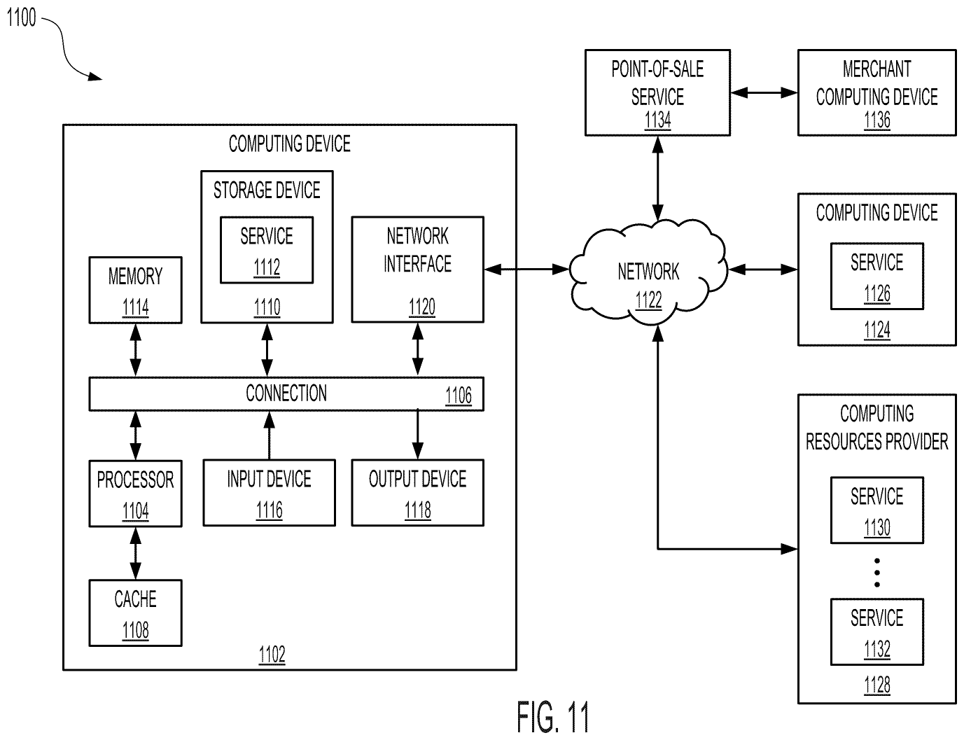

FIG. 1 shows an illustrative example of an environment 100 in which a user device 102 interacts with a provider system 104. The user device 102 may be a computing device such as the computing device 1102 described herein at least in connection with FIG. 11. The computing device 1102 can be used for any computer-implemented method in accordance with aspects described herein. The computing device may be, for example, a laptop computer, a desktop computer, a smartphone, a tablet, a smart watch, or any other type of computing device such as those described herein. As another example, a user may interact with a provider at a physical retail establishment, and the user device 102 may be a device provided by the retail establishment (i.e., as a point-of-sale service) to allow the user to interact with the provider. In one or more embodiments, the user device communicates with the provider system 104 over a network (not shown) such as the network 1122 described herein at least in connection with FIG. 11. The provider system 104 may be one or more computing devices such as the computing device 1102 described herein at least in connection with FIG. 11. As an example, the provider system 104 may be one or more server computing devices controlled or otherwise used by a provider (not shown). In one or more embodiments, a provider is any entity that offers for sale or otherwise provides any number of products (e.g., goods and/or services).

As an example, a user may use a browser application (not shown) or other application (not shown) of the user device 102 to peruse product offerings of a provider associated with the provider system 104, to access an account that the user has with the provider, etc. While the user accesses various webpages, online account management portals, or other channels that are offering product(s) of the provider and/or providing the ability for the user to interact with the provider (e.g., account management), certain user interface screens may be accompanied by options to redeem a gift presented as a user interface element (e.g., a box that includes text such as “Thanks for being one of our best customers” and an interactive user interface element (e.g., a button) that includes text such as “Redeem your gift”). Options to redeem a gift may be provided to a user physically (e.g., by mail). A gift may be any item, such as a good, service, gift card, coupon, experience opportunity (e.g., travel, dining, shopping spree, celebratory mecting, etc.), financial products (e.g., stocks, cryptographic currency, non-fungible tokens, etc.), points, etc. Other items may be considered gifts without departing from the scope of embodiments described herein.

In one or more embodiments, whether or not an option to redeem a gift is presented to a user may be determined by a reward offer algorithm 118 of a gifting service system 106. The determination may be triggered via the user device 102 accessing the provider system 104. Additionally or alternatively, the determination may be triggered prior to the access based on a request from the provider system 104 to the gifting service system 106. As an example, the provider system 104 may be associated with a service provider, such as a credit card service provider, and the provider may choose to engage the gifting service system 106 to determine whether the user qualifies as a best customer and, if so, be presented with an option to redeem a gift, which may occur when or before a user accesses the provider system 104 associated with the provider. In one or more embodiments, whether or not an option to redeem a gift is presented to a user may be determined on an on-going basis. As an example, user information may be monitored and assessed on an on-going basis, and based on user history, user behaviors, potential lifetime value of a user to a provider, etc., the gifting service may recommend to a provider to offer an option to redeem a gift to a particular user

The gifting service system 106 may be one or more computing devices such as the computing device 1102 described herein at least in connection with FIG. 11. As an example, the gifting service system 106 may be one or more server computing devices controlled or otherwise used by a gifting service provider (not shown). In one or more embodiments, the gifting service system 106 is configured to provide gifting services, which may be any number of ways to provide users, consumers, businesses, etc. with the ability to offer gifts in a variety of ways for a variety of purposes.

In one or more embodiments, the provider system 104 may provide product information and/or user information to gifting service system 106. In one or more embodiments, the gifting service system 106 includes a provider sub-system 108. The provider sub-system 108 may be one or more computing devices such as the computing device 1102 described herein at least in connection with FIG. 11, or any portion of such computing devices. In one or more embodiments, the provider sub-system 108 includes a datastore (not shown) that stores any data received from or otherwise obtained and related to the provider associated with provider system 104. As such, the provider sub-system 108 may store all or any portion of the product information (described below) received from the provider system 104, all or any portion of any user information (described below) received from the provider system 104 or otherwise obtained by the gifting service system 106.

In one or more embodiments, the product information is stored in a product information store 110 of the provider sub-system 108. The product information store 110 may be one or more computing devices such as the computing device 1102 described herein at least in connection with FIG. 11, or any portion of such computing devices (e.g., data storage for storing one or more data structures that include the product information). In one or more embodiments, the product information store 110 includes a datastore for storing any information related to products associated with the provider system 104, organized in any suitable one or more data structures, that may be offered as gifts to users.

In one or more embodiments, product information, provided from the provider system 104 to the gifting service system 106, may be any information related to any product that may be offered by the provider system 104 as a gift to a user for which a determination was made that the user qualifies to be provided with an option to redeem a gift (e.g., for being a “best customer” of the provider). Such product information may be stored in the product information store 110 of the provider sub-system 108 of the gifting service system 106. The product information may include, for example, names of products, identifiers of products, information about products (e.g., size options, color options, style options, etc.), images of products, etc. As another example, the product information may include categorization information defining what one or more categories of products that a given product of the provider is in. As another example the product information may include product pricing information. As another example, the product information may include identification of products that a provider wants to be offered to a user when a determination is made to present the user with an option to redeem a gift (e.g., for qualifying as a “best customer” of the provider). As another example, the product information may include identification of one or more specific gifts. For example, product information may include information indicating that a specific brand of products should be associated with one or more gift options that may be offered to a user. As another example product information may include information related to inventory levels of one or more products of a provider and/or of one or more gift options that may be offered to a user when a determination is made to provide the user with an opportunity to redeem a gift. Product information may be dynamically updated in real time. As an example, a provider or partner of a provider may provide updated and/or new product information from time to time, which may be used to dynamically update the product information in the product information store 110.

In one or more embodiments, a provider system 104 may be associated with one or more partner systems (not shown). A partner system may be one or more computing devices such as the computing device 1102 described herein at least in connection with FIG. 11. In one or more embodiments, a partner system is associated with a partner of the provider associated with the provider system 104. In one or more embodiments, a partner is any entity that has a relationship with the provider. As an example, a partner may be another provider or other entity that offers products (e.g., goods and/or services). In one or more embodiments, a partner may desire to provide its products as gifts to users identified as best customers relative to the provider system 104. For example, a partner may be seeking to gain customers for its products (e.g., as a marketing use case). To that end, the partner may enter into an agreement with the provider such that the provider will offer one or more products of the partner as gifts when a user qualifies as a best customer of the provider. As an example, the partner may seek to have the provider offer one or more partner products as gifts to users that qualify as best customers within a certain timeframe. As another example, the partner may seek to have the provider offer one or more products of the partner to users that purchase one or more products from the provider and are associated with certain characteristics (e.g., have certain demographic characteristics, spent above a certain amount on the purchase, etc.). In one or more embodiments, in order for one or more partner products to be offered as gifts to users, the partner system may provide product information. Such product information may be provided to the provider system 104. The provider system 104 may, in turn, provide the partner product information to the gifting service system 106 (as described above) as part of the product information provided by the provider system 104. Additionally or alternatively, the partner system may provide the partner product information to the gifting service system 106, and such product information may be stored in the product information store 110.

In one or more embodiments, the provider sub-system 108 includes a user information store 112. The user information store 112 may be one or more computing devices such as the computing device 1102 described herein at least in connection with FIG. 11, or any portion of such computing devices (e.g., data storage for storing one or more data structures that include user information). In one or more embodiments, the user information store 112 includes a datastore for storing any information related to users associated with the provider system 104, organized in any suitable one or more data structures.

User information stored in the user information store 112 may be obtained from the user information received from the provider system 104. Such information may further include any information about users obtained by the gifting service system 106 obtained from any other source for any other purpose. As an example, the gifting service system 106 may have interacted with the user previously (e.g., for redeeming a previous gift, providing gifting services, etc.) and obtained information about the user through the interaction. As another example, user information stored in the user information store 112 may include data related to users obtained via various online sources (e.g., cookies, clickstream data, search data, purchase data, user profile data, etc.), data corresponding to content presented on a website or application (e.g., dates, product details, images, videos, other advertisements, comments, news stories and headlines, etc.), data obtained from e-mails or social media posts/comments/profiles, etc. User information may be derived using machine learning techniques, obtained from mobile applications, obtained from websites, obtained from point-of-sale devices, etc.

In one or more embodiments, user information provided from the provider system 104 to the gifting service system 106 may include information related to the user for which the provider system 104 is seeking a determination as to whether the user qualifies to be provided with an option to redeem a gift (e.g., qualifies as a “best customer”). Such user information may include any information related to or otherwise associated with the user for which such a determination is requested. For example, the consumer may have created an account with the provider, and the provider system 104 may maintain a user profile associated with the user. All or any portion of the information maintained in such a user profile may be provided to the gifting service system 106 as part of the user information. As another example, the provider system 104 may provide information related to any number of users to the gifting service system 106 as user information. User information may include any information about a user such as, for example, demographic information (e.g., name, age, location, etc.), purchase and/or interaction history with the provider, length of time of the relationship between the provider and the user, one or more date ranges of interactions between the user and the provider system 104, etc., which may be obtained by the gifting service system 106 from a provider, and/or sources other than the provider system 104 (e.g., previous interactions with a user, cookies, browser extensions, social media platforms, etc.). User information related to a particular user and/or to one or more groups of users may be referred to as historical user information. In one or more embodiments, historical user information is dynamically updated in real-time. As an example, updates may be added to the historical user information as users make purchases from or otherwise interact with providers, decide whether or not to redeem gifts, make changes to social media profiles, update provider account profiles, etc.

In one or more embodiments, the gifting service system 106 includes a machine learning system 114. The machine learning system 114 may be implemented on one or more computing devices of the gifting service system 106, such as the computing device 1102 described herein at least in connection with FIG. 11, or any portion of such computing devices. Additionally or alternatively, the machine learning system 114 may be implemented as an application or other executable process on one or more computing devices of the gifting service system 106.

The machine learning system 114 may include a reward offer algorithm 118 that is configured to analyze user information stored in the user information store 112 in order to determine whether a user should be provided an offer to redeem a gift (e.g., whether the user qualifies as a “best customer” of the provider). The reward offer algorithm 118 may be implemented on one or more computing devices of the gifting service system 106, such as the computing device 1102 described herein at least in connection with FIG. 11, or any portion of such computing devices. Additionally or alternatively, the reward offer algorithm 118 may be implemented as an application or other executable process on one or more computing devices of the gifting service system 106.

In one or more embodiments, the reward offer algorithm 118 is invoked by the gifting service system 106 in response to receiving or otherwise obtaining or determining a request from the provider system 104 indicating that the provider system seeks a determination as to whether a particular user qualifies to receive an option to redeem a gift (e.g., qualifies as a best customer). Such a request may be made, for example, when the user device 102 accesses the provider system 104. Additionally or alternatively, the request may be made at any other time, such that the provider system is prepared to offer an option to redeem a gift to a qualified user the next time the user device 102 accesses the provider system 104.

The reward offer algorithm 118 may include any number of rules to be evaluated in order to determine whether a user qualifies to receive an offer to redeem a gift. The reward offer algorithm 118 may include rules that associate certain characteristics of a user with a determination as to whether the user qualifies as a best customer (e.g., qualifies to receive an offer to redeem a gift). Examples of such characteristics include, but are not limited to, length of time the user has been associated with the provider system 104, certain actions taken by the user (e.g., paid a bill, spent a certain amount, etc.), user demographic information, date range of an interaction between the user and the provider system 104, a user's interest level in a particular holiday, etc. As an example, the reward offer algorithm 118 may include rules that indicate that a user in a certain geographic region, that has been associated with the provider for more than a certain amount of time, and that has spent a certain amount with the provider over a given period of time qualifies as a best customer and, as such, qualifies to receive an offer to redeem a gift. In one or more embodiments, the above-described rules, and/or any other such rules, may be evaluated by the reward offer algorithm 118 in any combination to determine whether a given user qualifies to be provided with an option to redeem a gift.

In one or more embodiments, the reward offer algorithm 118 may be or include a machine learning model that is trained to determine whether a given user qualifies to receive an offer so receive an option to redeem a gift as a reward (e.g., for being a best customer). Such a machine learning model may use any user information in order to predict whether a given user qualifies to receive an offer to redeem a gift.

As an example, a provider may have a goal of improving user engagement by offering a gift to the best customers of the provider, and is seeking to offer a gift to the best 50,000 customers. To that end, the machine learning model may be trained to predict the likelihood that providing the offer to redeem a gift to a particular user will result in the user maintaining or increasing an engagement level with the provider, and only users with a likelihood over a defined threshold should receive such an offer. The machine learning model may be dynamically updated via continuous training over time to improve its predictive accuracy by adding user information, along with the result of whether the offer resulted in the redeeming of the gift and whether the user maintained or increased engagement with the retailer, to the training data set for the machine learning model, thereby allowing the machine learning model to better predict the likelihood that providing a user with an offer to redeem a gift will result in better engagement by the user with the provider. In other words, the machine learning model may thus be dynamically updated in real time with the results of providing users with offers to redeem gifts and the results of such an offer as such offers and results are happening.

Other machine learning techniques may be used as part of the reward offer algorithm 118 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the user information associated with a given user include characteristics similar to other users for which an offer to redeem a gift was made and resulted in the desired outcome of the provider.

In one or more embodiments, using user information, in response to receiving a request from the provider system 104 upon a user accessing the provider system 104, the reward offer algorithm 118 analyzes the user information (as described above) and generates a reward decision. In one or more embodiments, a reward decision is a decision as to whether or not a user should be presented with an offer to redeem a gift (e.g., for qualifying as a best customer of the provider). In one or more embodiments, the gifting service system 106 transmits the reward decision to the provider system 104. Additionally or alternatively, in one or more embodiments, the reward offer algorithm 118 may be invoked, as described above, before user interacts with the provider system 104. In such a scenario, the provider system 104 may be prepared to present the reward to the user at the time the user next accesses the provider system 104. In either scenario, the provider, via the provider system 104, may present a reward notification to the user via the user device 102.

The reward notification may be provided using any suitable technique for alerting the user that the user has received an option to redeem a gift. As an example, while the user is navigating a user interface (e.g., a website, mobile application etc.) of the provider system 104, a user interface element that includes an interactive user interface element (e.g., a button, a link, a quick response (QR) code, etc.) that informs the user that they have been selected to redeem a gift and to interact with the interactive user interface element to begin the redemption process. As another example, the reward notification may be transmitted to the user device 102 using any other suitable communication channel (e.g., email, text message, messaging service, etc.). As another example, the offer to redeem a gift may be presented at a particular point in the interaction between the user an the provider system 104 (e.g., upon completion of a purchase, at a landing page, after payment of a bill, etc.). As another example, the offer to redeem a gift may provided to a user physically (e.g., by mail).

In one or more embodiments, the one or more gifts to be offered to the user are determined via a gift options algorithm 116 of the machine learning system 114 of the gifting service system 106. The gift options algorithm 116 may be implemented on one or more computing devices of the gifting service system 106, such as the computing device 1102 described herein at least in connection with FIG. 11, or any portion of such computing devices. Additionally or alternatively, the gift options algorithm 116 may be implemented as an application or other executable process on one or more computing devices of the gifting service system 106. The gift options algorithm 116 may be invoked to determine gift options at the time the decision is made by the reward offer algorithm 118 to provide an offer to redeem a gift to a user, or any time thereafter (e.g., when the user selects to begin a gift redemption process). As used herein, a gift may be any item or service. Examples include, but are not limited to, a physical item, a gift card, a coupon, a service, etc.

In one or more embodiments, the gift options algorithm 116 analyzes user information from the user information store 112 and/or product information from the product information store 110 in order to determine which one or more gift options to provide to the user. As an example, the analysis may include determining that the user is interested in a particular brand, which is associated with one or more provider products and/or partner products that are to be offered as gifts. As another example, the analysis may include determining that the user made a purchase above a certain price, or within a certain price range, and that one or more particular gifts are to be offered with purchases having the price paid by the user. As another example, the analysis may include determining the date on which the user interacted with the provider system 104, and that one or more gift options are to be offered after interactions within a data range that the interaction date is within. As another example, the analysis may include evaluating inventory information to determine what one or more gifts exist in the inventory of the provider or partner of the provider that are to be offered as gifts to users that qualify as best customers of the provider. In one or more embodiments, all or any portion of the aforementioned example analyses may be performed by the gift options algorithm 116 in combination to determine what one or more gift options should be presented to the user.

In one or more embodiments, the gift options algorithm 116 may be or include a machine learning model that is trained to determine what one or more gifts should be presented to the user. As an example, such a machine learning model may use information from product information and/or user information in order to predict what potential gift options are more likely to result on the user electing to redeem a gift. In such a scenario, a provider may have a goal of increasing customer satisfaction with the provider, raising engagement levels, inducing more interaction with the user, etc. To that end, the machine learning model may be trained to predict which one or more particular gifts of the currently available gift options, when presented to the user, are more likely to cause the consumer to decide to redeem the gift.

As an example, the trained gift option machine learning model may be trained to determine that consumers having certain demographic characteristics, living in a certain geographic region, and that made a purchase of a particular brand, and that have been associated with the provider for more than a certain length of time are more likely to select to redeem the gift when a certain type of gift option is presented to the user. The machine learning model may be dynamically updated via continuous training over time to improve its predictive accuracy by adding product information and/or user information, the gift options presented in the offer or other offers for similar users, the results of whether the offer resulted in the redeeming of a gift, the acceptance of the gift by the user, and whether the user redeeming the gift exhibited desired behavior after the redemption, to the training data set for the machine learning model, thereby allowing the machine learning model to better predict gift options that are more likely to result in the redeeming of a gift.

Other machine learning techniques may be used as part of the gift options algorithm 116 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the product information and/or user information associated with or existing at the time of a given user interaction with the provider system 104 had characteristics similar to other users and/or gifts for which an offer to redeem a gift was made and resulted in the outcome(s) desired by the provider.

In one or more embodiments, the user may choose not to redeem a gift by not selecting the interactive element included with the reward notification to begin the process of redeeming the gift, in which case no gift options will be presented to the user, and no gift will be sent to the user. In one or more embodiments, if the user elects to redeem a gift by interacting with the interactive element included with the reward notification (e.g., selecting the button, clicking a text hyperlink, scanning the QR code, etc.), which may be referred to as making a reward redemption request, the gifting service system 106 may provide gift options to the user device 102.

In one or more embodiments, to provide the gift options, the gifting service system may direct the user device to a user interface (i.e., a webpage, mobile application screen, etc.) generated by the gifting service system 106. The user interface may include a presentation of a gift, such as an image, name, description, etc. of the gift. If there is more than one option of what gift may be received, the user interface may include a presentation of the various options via images, names, and/or descriptions of the gifts and a request to select from among the options (e.g., “What gift would you like to receive?”).

The gift options may include any other information without departing from the scope of embodiments described herein. As an example, the gift options may include an image of virtual gift wrapping, and an interactive element that, when selected by the user, reveals (e.g., “unwraps”) the gift. The interactive element may include a signal indicating to the user to select the interactive element to begin the gift redemption process (e.g., “SEE YOUR GIFT”) As another example, the gift options may include explanatory information that provides the user with various details related to the receipt of the gift (e.g., “You have received a gift. To redeem your gift, select the button above, and provide your address to have your gift shipped to you”). As another example, the gift options may include information that provides the user with other details about the gift redemption process (e.g., that the recipient will have the option to exchange the gift for another gift, that the recipient will have the option to select certain customization options related to the gift, etc.).

In one or more embodiments, the one or more gift options presented to the user may depend on when the consumer selects to send a gift (i.e., the timing of the selection to send the gift). As an example, the provider system 104 may transmit the offer to redeem a gift (e.g., the reward notification) in the form of an email. In such a scenario, the user may not immediately open the email, or may open the email but not immediately select to redeem the gift. Thus, the one or more gift options that would be presented to the user may have changed since the time that the reward notification was sent. For example, some or all of the gift options that would have been presented if the user had elected to send a gift near the time that the offer was sent may no longer be available (e.g., there were 1000 partner gifts, but all have already been sent). Therefore, the gift options algorithm 116 may be invoked (possibly again) at the time the user selects to redeem the gift in order to determine gift options that are available at the time of the redemption selection to be presented to the user. In one or more embodiments, the offer to redeem a gift may be provided via more than one channel. As an example, the offer may be sent to the user by mail. If such an offer is not responded to in a certain period of time, the user may also be provided the offer the next time the user accesses the provider system 104.

The gift options user interface may also provide various options to the user. Such options may include, but are not limited to, the option to accept the gift offered, or to exchange the gift for another gift from the provider or a partner of the provider. The user interface may include one or more alternate gifts that the user could choose to exchange for the one or more gifts selected by the gift options algorithm 116. The alternate gifts may be presented using an image, a name, and/or details of the one or more alternate gifts.

In one or more embodiments, the user interface presenting the one or more gift options to the user includes an interactive element (e.g., a button, link, etc.) that, when selected (after selecting a gift if more than one is offered), navigates the user to another user interface where additional information is requested from the user. The user interface may include any number of different requests for information from the user. As an example, the page may request that the consumer select a communication channel (e.g., email, text, messenger service, printed mail delivery, etc.) through which the consumer wants to receive information related to the gift. As another example, the page may include a request for a user identifier. The user identifier may include a preferred name of the user, as well as information that facilitates the gifting service system 106 to interact with the user via the user's selected communication channel (e.g., an email address, a phone number, etc.).

The user interface may also include an interactive element that, when selected, allows the user to continue the gift redemption process. The interactive element may change, depending on other selections made by the user. For example, the interactive element may be a button that, when selected by the user, navigates the user to another portion of the user interface to continue the gift redemption process. The interactive element may include a signal indicating to the user to select the interactive element to continue the process. The signal may, for example, be text, which may change based on other selections of the user. As an example, the text may state “Continue” if the recipient checks a check element on the page indicating that they would prefer to continue with the one of the gifts presented in the gift options, but change to “Exchange this gift” if the user checks a check element indicating that they would prefer to exchange the gift for an alternate gift. In one or more embodiments, if the user makes a selection indicating that the user wants to exchange the gift, then the elements on the user interface presenting the one or more alternate gift options may be selectable to allow the user to indicate which alternate gift the user prefers. In such a scenario, the page may also include an indication to the user that the user should select from among the alternate gift options.

In one or more embodiments, the alternate gift options presented to the user are determined by the gift options algorithm 116. As an example, the gift options algorithm 116 may include a predictive machine learning model that takes is provided with the rejection of the gift options, and used to predict the one or more alternate gifts.

In one or more embodiments, once the user has selected a gift, the user may be presented with various customization options (e.g., size, color, etc.) and requests for information (e.g., address to send the gift to, preferred delivery options, a digital wallet address (e.g., for cryptographic currency, non-fungible tokens, etc.), etc.). The collective information that includes selected gift, gift customization selections, address, preferred delivery options, preferred communication channel, user identifier, etc. may be referred to as redemption information. The redemption information may be transmitted from the user device 102 to the gifting service system 106.

Although the above description contemplates various presentations and user interface portions provided to the recipient to complete the gift redemption process, all or any portion of the presentations may be combined into a single user interface portion, or divided differently into separate user interface portions, without departing from the scope of embodiments described herein. As such, in one or more embodiments, the redemption information may be transmitted to the gifting service system 106 as a single transmission, or as a series of transmissions.

In one or more embodiments, once the recipient has made all necessary selections and provided the requested information (which may be referred to collectively as redemption information), the redemption information is transmitted from the user device 102 to the gifting service system 106. In one or more embodiments, based at least in part on the redemption information, the gifting service system 106 initiates delivery of the selected gift to the user. The method of delivery may be based on a selection made by the user during the gift redemption process by which the user indicated a preferred method of delivery. As an example, the gift may be a gift card, and the user may have selected to receive the gift card as a virtual gift card delivered via email. As another example, the gift may be a physical object, and the user may have provided a physical address to which the gift is shipped. The gifting service system 106 may perform the delivery of the gift. Additionally or alternatively, the gifting service system 106 may provide information related to the planned delivery to the provider system 104 and/or the partner system, and the provider system 104 and/or partner system may perform the delivery of the gift to the user. In one or more embodiments, regardless of which entity performs the delivery of the gift, information related to the user may be provided to the provider system 104 and/or to the partner system(s), thereby providing the provider and/or partner(s) with information including that a gift was redeemed by the user, what the gift was, and/or any other information obtained during the gift redemption process. In one or more embodiments, all or any portion of any information obtained related to the user during the gift redemption process is used by the gifting service system 106 to dynamically update historical data maintained by the user information store 112, which may be used to dynamically update the machine learning models of the reward offer algorithm 118 and/or the gift options algorithm 116 by adding the obtained information in real-time to the training data sets for the machine learning models. In one or more embodiments, all or any portion of the information obtained during the redemption process may be provided on request to third-party entities. As an example, a third-party business may seek to determine what types of rewards are being provided to a particular user, which may inform that business' decisions when determining what type of reward to separately offer the user.

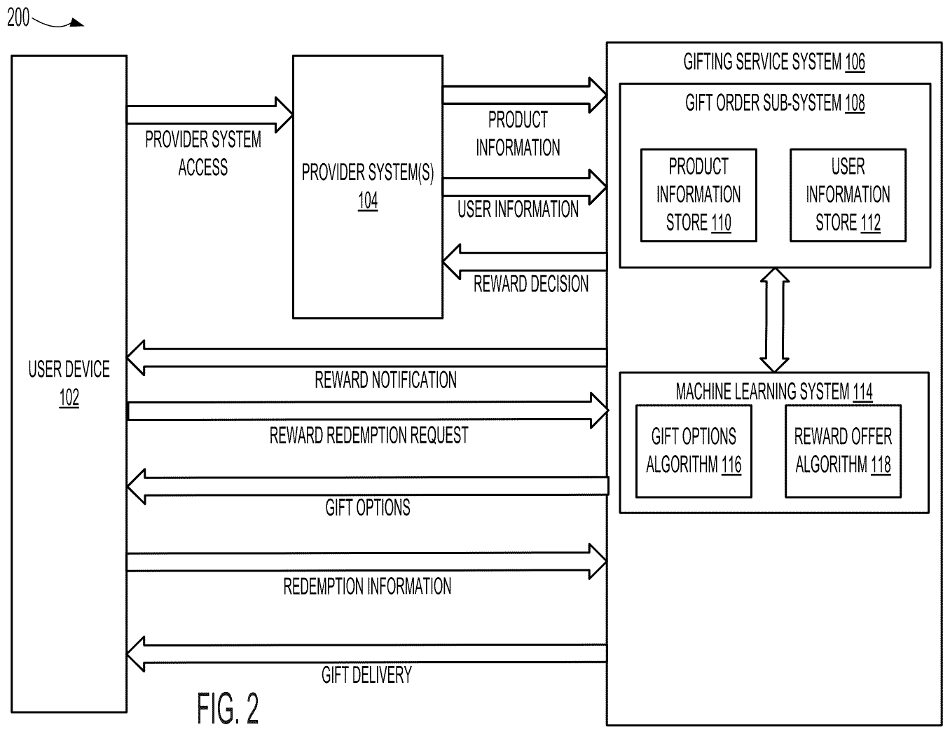

FIG. 2 shows an illustrative example of an environment 200 in which a user device 102 interacts with a provider system 104. The user device 102 may be a computing device such as the computing device 1102 described herein at least in connection with FIG. 11. The computing device may be, for example, a laptop computer, a desktop computer, a smartphone, a tablet, a smart watch, or any other type of computing device such as those described herein. As another example, a user may interact with a provider at a physical retail establishment, and the user device 102 may be a device provided by the retail establishment (i.e., as a point-of-sale service) to allow the user to interact with the provider. In one or more embodiments, the user device communicates with the provider system 104 over a network (not shown) such as the network 1122 described herein at least in connection with FIG. 11. The provider system 104 may be one or more computing devices such as the computing device 1102 described herein at least in connection with FIG. 11. As an example, the provider system 104 may be one or more server computing devices controlled or otherwise used by a provider (not shown). In one or more embodiments, a provider is any entity that offers for sale or otherwise provides any number of products (e.g., goods and/or services).

As an example, a user may use a browser application (not shown) or other application (not shown) of the user device 102 to peruse product offerings of a provider associated with the provider system 104, to access an account that the user has with the provider, etc. While the user accesses various webpages, online account management portals, or other channels that are offering product(s) of the provider and/or providing the ability for the user to interact with the provider (e.g., account management), certain user interface screens may be accompanied by options to redeem a gift presented as a user interface element (e.g., a box that includes text such as “Thanks for being one of our best customers” and an interactive user interface element (e.g., a button) that includes text such as “Redeem your gift”). A gift may be any item, such as a good, service, gift card, coupon, experience opportunity (e.g., travel, dining, etc.), etc. Other items may be considered gifts without departing from the scope of embodiments described herein.

In one or more embodiments, whether or not an option to redeem a gift is presented to a user may be determined by a reward offer algorithm 118 of a gifting service system 106. The determination may be triggered via the user device 102 accessing the provider system 104 (e.g., a provider system access). Additionally or alternatively, the determination may be triggered prior to the access based on a request from the provider system 104 to the gifting service system 106. As an example, the provider system 104 may be associated with a service provider, such as a credit card service provider, and the provider may choose to engage the gifting service system 106 to determine whether the user qualifies as a best customer and, if so, be presented with an option to redeem a gift, which may occur when or before a user accesses the provider system 104 associated with the provider.

The gifting service system 106 may be one or more computing devices such as the computing device 1102 described herein at least in connection with FIG. 11. As an example, the gifting service system 106 may be one or more server computing devices controlled or otherwise used by a gifting service provider (not shown). In one or more embodiments, the gifting service system 106 is configured to provide gifting services, which may be any number of ways to provide users, consumers, businesses, etc. with the ability to offer gifts in a variety of ways for a variety of purposes.

In one or more embodiments, the provider system 104 may provide product information and/or user information to gifting service system 106. In one or more embodiments, the gifting service system 106 includes a provider sub-system 108. The provider sub-system 108 may be one or more computing devices such as the computing device 1102 described herein at least in connection with FIG. 11, or any portion of such computing devices. In one or more embodiments, the provider sub-system 108 includes a datastore (not shown) that stores any data received from or otherwise obtained and related to the provider associated with provider system 104. As such, the provider sub-system 108 may store all or any portion of the product information (described below) received from the provider system 104, all or any portion of any user information (described below) received from the provider system 104 or otherwise obtained by the gifting service system 106.

In one or more embodiments, the product information is stored in a product information store 110 of the provider sub-system 108. The product information store 110 may be one or more computing devices such as the computing device 1102 described herein at least in connection with FIG. 11, or any portion of such computing devices (e.g., data storage for storing one or more data structures that include the product information). In one or more embodiments, the product information store 110 includes a datastore for storing any information related to products associated with the provider system 104, organized in any suitable one or more data structures, that may be offered as gifts to users.

In one or more embodiments, product information, provided from the provider system 104 to the gifting service system 106, may be any information related to any product that may be offered by the provider system 104 as a gift to a user for which a determination was made that the user qualifies to be provided with an option to redeem a gift (e.g., for being a “best customer” of the provider). Such product information may be stored in the product information store 110 of the provider sub-system 108 of the gifting service system 106. The product information may include, for example, names of products, identifiers of products, information about products (e.g., size options, color options, style options, etc.), images of products, etc. As another example, the product information may include categorization information defining what one or more categories of products that a given product of the provider is in. As another example the product information may include product pricing information. As another example, the product information may include identification of products that a provider wants to be offered to a user when a determination is made to present the user with an option to redeem a gift (e.g., for qualifying as a “best customer” of the provider). As another example, the product information may include identification of one or more specific gifts. For example, product information may include information indicating that a specific brand of products should be associated with one or more gift options that may be offered to a user. As another example product information may include information related to inventory levels of one or more products of a provider and/or of one or more gift options that may be offered to a user when a determination is made to provide the user with an opportunity to redeem a gift. Product information may be dynamically updated in real time. As an example, a provider or partner of a provider may provide updated and/or new product information from time to time, which may be used to dynamically update the product information in the product information store 110.

In one or more embodiments, a provider system 104 may be associated with one or more partner systems (not shown). A partner system may be one or more computing devices such as the computing device 1102 described herein at least in connection with FIG. 11. In one or more embodiments, a partner system is associated with a partner of the provider associated with the provider system 104. In one or more embodiments, a partner is any entity that has a relationship with the provider. As an example, a partner may be another provider or other entity that offers products (e.g., goods and/or services). In one or more embodiments, a partner may desire to provide its products as gifts to users identified as best customers relative to the provider system 104. For example, a partner may be seeking to gain customers for its products. To that end, the partner may enter into an agreement with the provider such that the provider will offer one or more products of the partner as gifts when a user qualifies as a best customer of the provider. As an example, the partner may seek to have the provider offer one or more partner products as gifts to users that qualify as best customers within a certain timeframe. As another example, the partner may seek to have the provider offer one or more products of the partner to users that purchase one or more products from the provider and are associated with certain characteristics (e.g., have certain demographic characteristics, spent above a certain amount on the purchase, etc.). In one or more embodiments, in order for one or more partner products to be offered as gifts to users, the partner system may provide product information. Such product information may be provided to the provider system 104. The provider system 104 may, in turn, provide the partner product information to the gifting service system 106 (as described above) as part of the product information provided by the provider system 104. Additionally or alternatively, the partner system may provide the partner product information to the gifting service system 106, and such product information may be stored in the product information store 110.

In one or more embodiments, the provider sub-system 108 includes a user information store 112. The user information store 112 may be one or more computing devices such as the computing device 1102 described herein at least in connection with FIG. 11, or any portion of such computing devices (e.g., data storage for storing one or more data structures that include user information). In one or more embodiments, the user information store 112 includes a datastore for storing any information related to users associated with the provider system 104, organized in any suitable one or more data structures.

User information stored in the user information store 112 may be obtained from the user information received from the provider system 104. Such information may further include any information about users obtained by the gifting service system 106 obtained from any other source for any other purpose. As an example, the gifting service system 106 may have interacted with the user previously (e.g., for redeeming a previous gift, providing gifting services, etc.) and obtained information about the user through the interaction. As another example, user information stored in the user information store 112 may include data related to users obtained via various online sources (e.g., cookies, clickstream data, search data, purchase data, user profile data, etc.), data corresponding to content presented on a website or application (e.g., dates, product details, images, videos, other advertisements, comments, news stories and headlines, etc.), data obtained from e-mails or social media posts/comments/profiles, etc.

In one or more embodiments, user information provided from the provider system 104 to the gifting service system 106 may include information related to the user for which the provider system 104 is seeking a determination as to whether the user qualifies to be provided with an option to redeem a gift (e.g., qualifies as a “best customer”). Such user information may include any information related to or otherwise associated with the user for which such a determination is requested. For example, the consumer may have created an account with the provider, and the provider system 104 may maintain a user profile associated with the user. All or any portion of the information maintained in such a user profile may be provided to the gifting service system 106 as part of the user information. As another example, the provider system 104 may provide information related to any number of users to the gifting service system 106 as user information. User information may include any information about a user such as, for example, demographic information (e.g., name, age, location, etc.), purchase and/or interaction history with the provider, length of time of the relationship between the provider and the user, one or more date ranges of interactions between the user and the provider system 104, etc., which may be obtained by the gifting service system 106 from a provider, and/or sources other than the provider system 104 (e.g., previous interactions with a user, cookies, browser extensions, social media platforms, etc.). User information related to a particular user and/or to one or more groups of users may be referred to as historical user information. In one or more embodiments, historical user information is dynamically updated in real-time. As an example, updates may be added to the historical user information as users make purchases from or otherwise interact with providers, decide whether or not to redeem gifts, make changes to social media profiles, update provider account profiles, etc.

In one or more embodiments, the gifting service system 106 includes a machine learning system 114. The machine learning system 114 may be implemented on one or more computing devices of the gifting service system 106, such as the computing device 1102 described herein at least in connection with FIG. 11, or any portion of such computing devices. Additionally or alternatively, the machine learning system 114 may be implemented as an application or other executable process on one or more computing devices of the gifting service system 106.

The machine learning system 114 may include a reward offer algorithm 118 that is configured to analyze user information stored in the user information store 112 in order to determine whether a user should be provided an offer to redeem a gift (e.g., whether the user qualifies as a “best customer” of the provider). The reward offer algorithm 118 may be implemented on one or more computing devices of the gifting service system 106, such as the computing device 1102 described herein at least in connection with FIG. 11, or any portion of such computing devices. Additionally or alternatively, the reward offer algorithm 118 may be implemented as an application or other executable process on one or more computing devices of the gifting service system 106.

In one or more embodiments, the reward offer algorithm 118 is invoked by the gifting service system 106 in response to receiving or otherwise obtaining or determining a request from the provider system 104 indicating that the provider system seeks a determination as to whether a particular user qualifies to receive an option to redeem a gift (e.g., qualifies as a best customer). Such a request may be made, for example, when the user device 102 accesses the provider system 104. Additionally or alternatively, the request may be made at any other time, such that the provider system is prepared to offer an option to redeem a gift to a qualified user the next time the user device 102 accesses the provider system 104.

The reward offer algorithm 118 may include any number of rules to be evaluated in order to determine whether a user qualifies to receive an offer to redeem a gift. The reward offer algorithm 118 may include rules that associate certain characteristics of a user with a determination as to whether the user qualifies as a best customer (e.g., qualifies to receive an offer to redeem a gift). Examples of such characteristics include, but are not limited to, length of time the user has been associated with the provider system 104, certain actions taken by the user (e.g., paid a bill, spent a certain amount, etc.), user demographic information, date range of an interaction between the user and the provider system 104, a user's interest level in a particular holiday, etc. As an example, the reward offer algorithm 118 may include rules that indicate that a user in a certain geographic region, that has been associated with the provider for more than a certain amount of time, and that has spent a certain amount with the provider over a given period of time qualifies as a best customer and, as such, qualifies to receive an offer to redeem a gift. In one or more embodiments, the above-described rules, and/or any other such rules, may be evaluated by the reward offer algorithm 118 in any combination to determine whether a given user qualifies to be provided with an option to redeem a gift.

In one or more embodiments, the reward offer algorithm 118 may be or include a machine learning model that is trained to determine whether a given user qualifies to receive an offer so receive an option to redeem a gift as a reward (e.g., for being a best customer). Such a machine learning model may use any user information in order to predict whether a given user qualifies to receive an offer to redeem a gift.

As an example, a provider may have a goal of improving user engagement by offering a gift to the best customers of the provider, and is seeking to offer a gift to the best 50,000 customers. To that end, the machine learning model may be trained to predict the likelihood that providing the offer to redeem a gift to a particular user will result in the user maintaining or increasing an engagement level with the provider, and only users with a likelihood over a defined threshold should receive such an offer. The machine learning model may be dynamically updated via continuous training over time to improve its predictive accuracy by adding user information, along with the result of whether the offer resulted in the redeeming of the gift and whether the user maintained or increased engagement with the retailer, to the training data set for the machine learning model, thereby allowing the machine learning model to better predict the likelihood that providing a user with an offer to redeem a gift will result in better engagement by the user with the provider.

Other machine learning techniques may be used as part of the reward offer algorithm 118 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the user information associated with a given user include characteristics similar to other users for which an offer to redeem a gift was made and resulted in the desired outcome of the provider.

In one or more embodiments, using user information, in response to receiving a request from the provider system 104 upon a user accessing the provider system 104, the reward offer algorithm 118 analyzes the user information (as described above) and generates a reward decision. In one or more embodiments, a reward decision is a decision as to whether or not a user should be presented with an offer to redeem a gift (e.g., for qualifying as a best customer of the provider). In one or more embodiments, the gifting service system 106 transmits the reward decision to the provider system 104. Additionally or alternatively, in one or more embodiments, the reward offer algorithm 118 may be invoked, as described above, before user interacts with the provider system 104. In such a scenario, the provider system 104 may be prepared to present the reward to the user at the time the user next accesses the provider system 104.

The environment 200 shown in FIG. 2 differs from the environment 100 shown in FIG. 1 in that, after the reward decision has been provided to the provider system 104, the a reward notification is transmitted to the user device 102 from the gifting service system 106 rather than from the provider system 104. In the scenario where the request for a determination as to whether a user qualifies to be provided with an option to redeem a gift when the user accesses the provider system 104, the reward notification may be presented to the user while the user is interactive with the provider system 104. Such a presentation may, for example, occur via the gifting service system 106 by accessing embedded code in the user interface of the provider system 104 to provide the option to redeem a gift. As another example, the gifting service system may provide the reward notification using a separate communication channel (e.g., email, text, messaging service, etc.)

The reward notification may be presented using any suitable technique for alerting the user that the user has received an option to redeem a gift. As an example, while the user is navigating a user interface (e.g., a website, mobile application etc.) of the provider system 104, a user interface element that includes an interactive user interface element provided by the gifting service system through embedded code in a certain region of the user interface designed to allow the gifting service system to provide content (e.g., a button, a link, a quick response (QR) code, etc.) may be presented that informs the user that they have been selected to redeem a gift and to interact with the interactive user interface element to begin the redemption process.

In one or more embodiments, the one or more gifts to be offered to the user are determined via a gift options algorithm 116 of the machine learning system 114 of the gifting service system 106. The gift options algorithm 116 may be implemented on one or more computing devices of the gifting service system 106, such as the computing device 1102 described herein at least in connection with FIG. 11, or any portion of such computing devices. Additionally or alternatively, the gift options algorithm 116 may be implemented as an application or other executable process on one or more computing devices of the gifting service system 106. The gift options algorithm 116 may be invoked to determine gift options at the time the decision is made by the reward offer algorithm 118 to provide an offer to redeem a gift to a user, or any time thereafter (e.g., when the user selects to begin a gift redemption process). As used herein, a gift may be any item or service. Examples include, a good, service, gift card, coupon, experience opportunity (e.g., travel, dining, shopping spree, celebratory meeting, etc.), financial products (e.g., stocks, cryptographic currency, non-fungible tokens, etc.), points, etc.

In one or more embodiments, the gift options algorithm 116 analyzes user information from the user information store 112 and/or product information from the product information store 110 in order to determine which one or more gift options to provide to the user. As an example, the analysis may include determining that the user is interested in a particular brand, which is associated with one or more provider products and/or partner products that are to be offered as gifts. As another example, the analysis may include determining that the user made a purchase above a certain price, or within a certain price range, and that one or more particular gifts are to be offered with purchases having the price paid by the user. As another example, the analysis may include determining the date on which the user interacted with the provider system 104, and that one or more gift options are to be offered after interactions within a data range that the interaction date is within. As another example, the analysis may include evaluating inventory information to determine what one or more gifts exist in the inventory of the provider or partner of the provider that are to be offered as gifts to users that qualify as best customers of the provider. In one or more embodiments, all or any portion of the aforementioned example analyses may be performed by the gift options algorithm 116 in combination to determine what one or more gift options should be presented to the user.

In one or more embodiments, the gift options algorithm 116 may be or include a machine learning model that is trained to determine what one or more gifts should be presented to the user. As an example, such a machine learning model may use information from product information and/or user information in order to predict what potential gift options are more likely to result on the user electing to redeem a gift. In such a scenario, a provider may have a goal of increasing customer satisfaction with the provider, raising engagement levels, inducing more interaction with the user, etc. To that end, the machine learning model may be trained in real time to predict which one or more particular gifts of the currently available gift options, when presented to the user, are more likely to cause the consumer to decide to redeem the gift.

As an example, the trained gift option machine learning model may be trained to determine that consumers having certain demographic characteristics, living in a certain geographic region, and that made a purchase of a particular brand, and that have been associated with the provider for more than a certain length of time are more likely to select to redeem the gift when a certain type of gift option is presented to the user. The machine learning model may be dynamically updated via continuous training over time to improve its predictive accuracy by adding product information and/or user information, the gift options presented in the offer or other offers for similar users, the results of whether the offer resulted in the redeeming of a gift, the acceptance of the gift by the user, and whether the user redeeming the gift exhibited desired behavior after the redemption, to the training data set for the machine learning model, thereby allowing the machine learning model to better predict gift options that are more likely to result in the redeeming of a gift.

Other machine learning techniques may be used as part of the gift options algorithm 116 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the product information and/or user information associated with or existing at the time of a given user interaction with the provider system 104 had characteristics similar to other users and/or gifts for which an offer to redeem a gift was made and resulted in the outcome(s) desired by the provider.

In one or more embodiments, the user may choose not to redeem a gift by not selecting the interactive element included with the reward notification to begin the process of redeeming the gift, in which case no gift options will be presented to the user, and no gift will be sent to the user. In one or more embodiments, if the user elects to redeem a gift by interacting with the interactive element included with the reward notification (e.g., selecting the button, clicking a text hyperlink, scanning the QR code, etc.), which may be referred to as making a reward redemption request, the gifting service system 106 may provide gift options to the user device 102.

In one or more embodiments, to provide the gift options, the gifting service system may direct the user device to a user interface (i.e., a webpage, mobile application screen, etc.) generated by the gifting service system 106. The user interface may include a presentation of a gift, such as an image, name, description, etc. of the gift. If there is more than one option of what gift may be received, the user interface may include a presentation of the various options via images, names, and/or descriptions of the gifts and a request to select from among the options (e.g., “What gift would you like to receive?”).

The gift options may include any other information without departing from the scope of embodiments described herein. As an example, the gift options may include an image of virtual gift wrapping, and an interactive element that, when selected by the user, reveals (e.g., “unwraps”) the gift. The interactive element may include a signal indicating to the user to select the interactive element to begin the gift redemption process (e.g., “SEE YOUR GIFT”) As another example, the gift options may include explanatory information that provides the user with various details related to the receipt of the gift (e.g., “You have received a gift. To redeem your gift, select the button above, and provide your address to have your gift shipped to you”). As another example, the gift options may include information that provides the user with other details about the gift redemption process (e.g., that the recipient will have the option to exchange the gift for another gift, that the recipient will have the option to select certain customization options related to the gift, etc.).

In one or more embodiments, the one or more gift options presented to the user may depend on when the consumer selects to send a gift (i.e., the timing of the selection to send the gift). As an example, the provider system 104 may transmit the offer to redeem a gift (e.g., the reward notification) in the form of an email. In such a scenario, the user may not immediately open the email, or may open the email but not immediately select to redeem the gift. Thus, the one or more gift options that would be presented to the user may have changed since the time that the reward notification was sent. For example, some or all of the gift options that would have been presented if the user had elected to send a gift near the time that the offer was sent may no longer be available (e.g., there were 1000 partner gifts, but all have already been sent). Therefore, the gift options algorithm 116 may be invoked (possibly again) at the time the user selects to redeem the gift in order to determine gift options that are available at the time of the redemption selection to be presented to the user.

The gift options user interface may also provide various options to the user. Such options may include, but are not limited to, the option to accept the gift offered, or to exchange the gift for another gift from the provider or a partner of the provider. The user interface may include one or more alternate gifts that the user could choose to exchange for the one or more gifts selected by the gift options algorithm 116. The alternate gifts may be presented using an image, a name, and/or details of the one or more alternate gifts.

In one or more embodiments, the user interface presenting the one or more gift options to the user includes an interactive element (e.g., a button, link, etc.) that, when selected (after selecting a gift if more than one is offered), navigates the user to another user interface where additional information is requested from the user. The user interface may include any number of different requests for information from the user. As an example, the page may request that the consumer select a communication channel (e.g., email, text, messenger service, printed mail delivery, etc.) through which the consumer wants to receive information related to the gift. As another example, the page may include a request for a user identifier. The user identifier may include a preferred name of the user, as well as information that facilitates the gifting service system 106 to interact with the user via the user's selected communication channel (e.g., an email address, a phone number, etc.).

The user interface may also include an interactive element that, when selected, allows the user to continue the gift redemption process. The interactive element may change, depending on other selections made by the user. For example, the interactive element may be a button that, when selected by the user, navigates the user to another portion of the user interface to continue the gift redemption process. The interactive element may include a signal indicating to the user to select the interactive element to continue the process. The signal may, for example, be text, which may change based on other selections of the user. As an example, the text may state “Continue” if the recipient checks a check element on the page indicating that they would prefer to continue with the one of the gifts presented in the gift options, but change to “Exchange this gift” if the user checks a check element indicating that they would prefer to exchange the gift for an alternate gift. In one or more embodiments, if the user makes a selection indicating that the user wants to exchange the gift, then the elements on the user interface presenting the one or more alternate gift options may be selectable to allow the user to indicate which alternate gift the user prefers. In such a scenario, the page may also include an indication to the user that the user should select from among the alternate gift options.

In one or more embodiments, the alternate gift options presented to the user are determined by the gift options algorithm 116. As an example, the gift options algorithm 116 may include a predictive machine learning model that takes is provided with the rejection of the gift options, and used to predict the one or more alternate gifts.

In one or more embodiments, once the user has selected a gift, the user may be presented with various customization options (e.g., size, color, etc.) and requests for information (e.g., address to send the gift to, preferred delivery options, etc.). The collective information that includes selected gift, gift customization selections, address, preferred delivery options, preferred communication channel, user identifier, etc. may be referred to as redemption information. The redemption information may be transmitted from the user device 102 to the gifting service system 106.

Although the above description contemplates various presentations and user interface portions provided to the recipient to complete the gift redemption process, all or any portion of the presentations may be combined into a single user interface portion, or divided differently into separate user interface portions, without departing from the scope of embodiments described herein. As such, in one or more embodiments, the redemption information may be transmitted to the gifting service system 106 as a single transmission, or as a series of transmissions.

In one or more embodiments, once the recipient has made all necessary selections and provided the requested information (which may be referred to collectively as redemption information), the redemption information is transmitted from the user device 102 to the gifting service system 106. In one or more embodiments, based at least in part on the redemption information, the gifting service system 106 initiates delivery of the selected gift to the user. The method of delivery may be based on a selection made by the user during the gift redemption process by which the user indicated a preferred method of delivery. As an example, the gift may be a gift card, and the user may have selected to receive the gift card as a virtual gift card delivered via email. As another example, the gift may be a physical object, and the user may have provided a physical address to which the gift is shipped. The gifting service system 106 may perform the delivery of the gift. Additionally or alternatively, the gifting service system 106 may provide information related to the planned delivery to the provider system 104 and/or the partner system, and the provider system 104 and/or partner system may perform the delivery of the gift to the user. In one or more embodiments, regardless of which entity performs the delivery of the gift, information related to the user may be provided to the provider system 104 and/or to the partner system(s), thereby providing the provider and/or partner(s) with information including that a gift was redeemed by the user, what the gift was, and/or any other information obtained during the gift redemption process. In one or more embodiments, all or any portion of any information obtained related to the user during the gift redemption process is used by the gifting service system 106 to dynamically update historical data maintained by the user information store 112, which may be used to dynamically update the machine learning models of the reward offer algorithm 118 and/or the gift options algorithm 116 by adding the obtained information in real-time to the training data sets for the machine learning models.

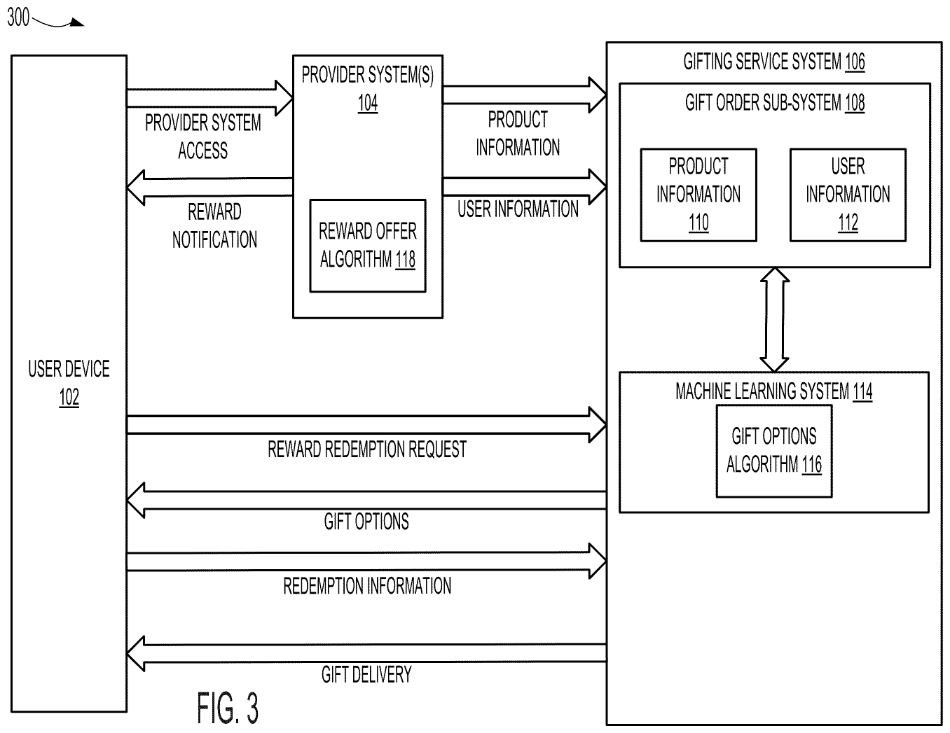

FIG. 3 shows an illustrative example of an environment 300 in which a user device 102 interacts with a provider system 104. The user device 102 may be a computing device such as the computing device 1102 described herein at least in connection with FIG. 11. The computing device may be, for example, a laptop computer, a desktop computer, a smartphone, a tablet, a smart watch, or any other type of computing device such as those described herein. As another example, a user may interact with a provider at a physical retail establishment, and the user device 102 may be a device provided by the retail establishment (i.e., as a point-of-sale service) to allow the user to interact with the provider. In one or more embodiments, the user device communicates with the provider system 104 over a network (not shown) such as the network 1122 described herein at least in connection with FIG. 11. The provider system 104 may be one or more computing devices such as the computing device 1102 described herein at least in connection with FIG. 11. As an example, the provider system 104 may be one or more server computing devices controlled or otherwise used by a provider (not shown). In one or more embodiments, a provider is any entity that offers for sale or otherwise provides any number of products (e.g., goods and/or services).

As an example, a user may use a browser application (not shown) or other application (not shown) of the user device 102 to peruse product offerings of a provider associated with the provider system 104, to access an account that the user has with the provider, etc. While the user accesses various webpages, online account management portals, or other channels that are offering product(s) of the provider and/or providing the ability for the user to interact with the provider (e.g., account management), certain user interface screens may be accompanied by options to redeem a gift presented as a user interface element (e.g., a box that includes text such as “Thanks for being one of our best customers” and an interactive user interface element (e.g., a button) that includes text such as “Redeem your gift”). A gift may be any item, such as a good, service, gift card, coupon, experience opportunity (e.g., travel, dining, etc.), etc. Other items may be considered gifts without departing from the scope of embodiments described herein.

In one or more embodiments, whether or not an option to redeem a gift is presented to a user may be determined by a reward offer algorithm 118. The environment 300 shown in FIG. 3 differs from the environment 100 shown in FIG. 1 and the environment 200 shown in FIG. 2 in that the reward offer algorithm 118 is included in the provider system 104 rather than the gifting service system 106. The determination may be triggered via the user device 102 accessing the provider system 104. Additionally or alternatively, the determination may be triggered prior to the access based on a desire of the provider to be prepared to offer a gift as a reward the next time the user accesses the provider system 104. As an example, the provider system 104 may be associated with a service provider, such as a credit card service provider, and the provider may choose to determine whether the user qualifies as a best customer and, if so, be presented with an option to redeem a gift, which may occur when or before a user accesses the provider system 104 associated with the provider.

The gifting service system 106 may be one or more computing devices such as the computing device 1102 described herein at least in connection with FIG. 11. As an example, the gifting service system 106 may be one or more server computing devices controlled or otherwise used by a gifting service provider (not shown). In one or more embodiments, the gifting service system 106 is configured to provide gifting services, which may be any number of ways to provide users, consumers, businesses, etc. with the ability to offer gifts in a variety of ways for a variety of purposes.

In one or more embodiments, the provider system 104 may provide product information and/or user information to gifting service system 106. In one or more embodiments, the gifting service system 106 includes a provider sub-system 108. The provider sub-system 108 may be one or more computing devices such as the computing device 1102 described herein at least in connection with FIG. 11, or any portion of such computing devices. In one or more embodiments, the provider sub-system 108 includes a datastore (not shown) that stores any data received from or otherwise obtained and related to the provider associated with provider system 104. As such, the provider sub-system 108 may store all or any portion of the product information (described below) received from the provider system 104, all or any portion of any user information (described below) received from the provider system 104 or otherwise obtained by the gifting service system 106.

In one or more embodiments, the product information is stored in a product information store 110 of the provider sub-system 108. The product information store 110 may be one or more computing devices such as the computing device 1102 described herein at least in connection with FIG. 11, or any portion of such computing devices (e.g., data storage for storing one or more data structures that include the product information). In one or more embodiments, the product information store 110 includes a datastore for storing any information related to products associated with the provider system 104, organized in any suitable one or more data structures, that may be offered as gifts to users.

In one or more embodiments, product information, provided from the provider system 104 to the gifting service system 106, may be any information related to any product that may be offered by the provider system 104 as a gift to a user for which a determination was made that the user qualifies to be provided with an option to redeem a gift (e.g., for being a “best customer” of the provider). Such product information may be stored in the product information store 110 of the provider sub-system 108 of the gifting service system 106. The product information may include, for example, names of products, identifiers of products, information about products (e.g., size options, color options, style options, etc.), images of products, etc. As another example, the product information may include categorization information defining what one or more categories of products that a given product of the provider is in. As another example the product information may include product pricing information. As another example, the product information may include identification of products that a provider wants to be offered to a user when a determination is made to present the user with an option to redeem a gift (e.g., for qualifying as a “best customer” of the provider). As another example, the product information may include identification of one or more specific gifts. For example, product information may include information indicating that a specific brand of products should be associated with one or more gift options that may be offered to a user. As another example product information may include information related to inventory levels of one or more products of a provider and/or of one or more gift options that may be offered to a user when a determination is made to provide the user with an opportunity to redeem a gift. Product information may be dynamically updated in real time. As an example, a provider or partner of a provider may provide updated and/or new product information from time to time, which may be used to dynamically update the product information in the product information store 110.

In one or more embodiments, a provider system 104 may be associated with one or more partner systems (not shown). A partner system may be one or more computing devices such as the computing device 1102 described herein at least in connection with FIG. 11. In one or more embodiments, a partner system is associated with a partner of the provider associated with the provider system 104. In one or more embodiments, a partner is any entity that has a relationship with the provider. As an example, a partner may be another provider or other entity that offers products (e.g., goods and/or services). In one or more embodiments, a partner may desire to provide its products as gifts to users identified as best customers relative to the provider system 104. For example, a partner may be seeking to gain customers for its products. To that end, the partner may enter into an agreement with the provider such that the provider will offer one or more products of the partner as gifts when a user qualifies as a best customer of the provider. As an example, the partner may seek to have the provider offer one or more partner products as gifts to users that qualify as best customers within a certain timeframe. As another example, the partner may seek to have the provider offer one or more products of the partner to users that purchase one or more products from the provider and are associated with certain characteristics (e.g., have certain demographic characteristics, spent above a certain amount on the purchase, etc.). In one or more embodiments, in order for one or more partner products to be offered as gifts to users, the partner system may provide product information. Such product information may be provided to the provider system 104. The provider system 104 may, in turn, provide the partner product information to the gifting service system 106 (as described above) as part of the product information provided by the provider system 104. Additionally or alternatively, the partner system may provide the partner product information to the gifting service system 106, and such product information may be stored in the product information store 110.

In one or more embodiments, the provider sub-system 108 includes a user information store 112. The user information store 112 may be one or more computing devices such as the computing device 1102 described herein at least in connection with FIG. 11, or any portion of such computing devices (e.g., data storage for storing one or more data structures that include user information). In one or more embodiments, the user information store 112 includes a datastore for storing any information related to users associated with the provider system 104, organized in any suitable one or more data structures.

User information stored in the user information store 112 may be obtained from the user information received from the provider system 104. Such information may further include any information about users obtained by the gifting service system 106 obtained from any other source for any other purpose. As an example, the gifting service system 106 may have interacted with the user previously (e.g., for redeeming a previous gift, providing gifting services, etc.) and obtained information about the user through the interaction. As another example, user information stored in the user information store 112 may include data related to users obtained via various online sources (e.g., cookies, clickstream data, search data, purchase data, user profile data, etc.), data corresponding to content presented on a website or application (e.g., dates, product details, images, videos, other advertisements, comments, news stories and headlines, etc.), data obtained from e-mails or social media posts/comments/profiles, etc.

In one or more embodiments, user information provided from the provider system 104 to the gifting service system 106 may include information related to the user for which the provider system 104 is making determination, using the reward offer algorithm 118 of the provider system 104, as to whether the user qualifies to be provided with an option to redeem a gift (e.g., qualifies as a “best customer”). Such user information may include any information related to or otherwise associated with the user for which such a determination being made by the provider system 104 using the reward offer algorithm 118. For example, the consumer may have created an account with the provider, and the provider system 104 may maintain a user profile associated with the user. All or any portion of the information maintained in such a user profile may be provided to the gifting service system 106 as part of the user information. As another example, the provider system 104 may provide information related to any number of users to the gifting service system 106 as user information. User information may include any information about a user such as, for example, demographic information (e.g., name, age, location, etc.), purchase and/or interaction history with the provider, length of time of the relationship between the provider and the user, one or more date ranges of interactions between the user and the provider system 104, etc., which may be obtained by the gifting service system 106 from a provider, and/or sources other than the provider system 104 (e.g., previous interactions with a user, cookies, browser extensions, social media platforms, etc.). User information related to a particular user and/or to one or more groups of users may be referred to as historical user information. In one or more embodiments, historical user information is dynamically updated in real-time. As an example, updates may be added to the historical user information as users make purchases from or otherwise interact with providers, decide whether or not to redeem gifts, make changes to social media profiles, update provider account profiles, etc. In one or more embodiments, all or any portion of the aforementioned user information is also stored by the provider system 104 to be used, at least in part, as input for the reward offer algorithm 118 of the provider system 104.

In one or more embodiments, as discussed above, the provider system 104 of environment 300 includes a reward offer algorithm 118 that is configured to analyze user information in order to determine whether a user should be provided an offer to redeem a gift (e.g., whether the user qualifies as a “best customer” of the provider). The reward offer algorithm 118 may be implemented on one or more computing devices of the provider system 104, such as the computing device 1102 described herein at least in connection with FIG. 11, or any portion of such computing devices. Additionally or alternatively, the reward offer algorithm 118 may be implemented as an application or other executable process on one or more computing devices of the provider system 104.

In one or more embodiments, the reward offer algorithm 118 is invoked when a user accesses the provider system 104. Additionally or alternatively, the request may be made at any other time, such that the provider system is prepared to offer an option to redeem a gift to a qualified user the next time the user device 102 accesses the provider system 104.

The reward offer algorithm 118 may include any number of rules to be evaluated in order to determine whether a user qualifies to receive an offer to redeem a gift. The reward offer algorithm 118 may include rules that associate certain characteristics of a user with a determination as to whether the user qualifies as a best customer (e.g., qualifies to receive an offer to redeem a gift). Examples of such characteristics include, but are not limited to, length of time the user has been associated with the provider system 104, certain actions taken by the user (e.g., paid a bill, spent a certain amount, etc.), user demographic information, date range of an interaction between the user and the provider system 104, a user's interest level in a particular holiday, etc. As an example, the reward offer algorithm 118 may include rules that indicate that a user in a certain geographic region, that has been associated with the provider for more than a certain amount of time, and that has spent a certain amount with the provider over a given period of time qualifies as a best customer and, as such, qualifies to receive an offer to redeem a gift. In one or more embodiments, the above-described rules, and/or any other such rules, may be evaluated by the reward offer algorithm 118 in any combination to determine whether a given user qualifies to be provided with an option to redeem a gift.

In one or more embodiments, the reward offer algorithm 118 may be or include a machine learning model that is trained to determine whether a given user qualifies to receive an offer so receive an option to redeem a gift as a reward (e.g., for being a best customer). Such a machine learning model may use any user information in order to predict whether a given user qualifies to receive an offer to redeem a gift.

As an example, a provider may have a goal of improving user engagement by offering a gift to the best customers of the provider, and is seeking to offer a gift to the best 50,000 customers. To that end, the machine learning model may be trained to predict the likelihood that providing the offer to redeem a gift to a particular user will result in the user maintaining or increasing an engagement level with the provider, and only users with a likelihood over a defined threshold should receive such an offer. The machine learning model may be dynamically updated via continuous training over time to improve its predictive accuracy by adding user information, along with the result of whether the offer resulted in the redeeming of the gift and whether the user maintained or increased engagement with the retailer, to the training data set for the machine learning model, thereby allowing the machine learning model to better predict the likelihood that providing a user with an offer to redeem a gift will result in better engagement by the user with the provider.

Other machine learning techniques may be used as part of the reward offer algorithm 118 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the user information associated with a given user include characteristics similar to other users for which an offer to redeem a gift was made and resulted in the desired outcome of the provider.

In one or more embodiments, using user information, the reward offer algorithm 118 analyzes the user information (as described above) and generates a reward decision. In one or more embodiments, a reward decision is a decision as to whether or not a user should be presented with an offer to redeem a gift (e.g., for qualifying as a best customer of the provider). In one or more embodiments, when the reward decision is that the user qualifies to receive an option to redeem a gift (e.g., the customer is a “best customer” of the provider), the provider, via the provider system 104, may present a reward notification to the user via the user device 102.

The reward notification may be provided using any suitable technique for alerting the user that the user has received an option to redeem a gift. As an example, while the user is navigating a user interface (e.g., a website, mobile application etc.) of the provider system 104, a user interface element that includes an interactive user interface element (e.g., a button, a link, a quick response (QR) code, etc.) that informs the user that they have been selected to redeem a gift and to interact with the interactive user interface element to begin the redemption process. As another example, the reward notification may be transmitted to the user device 102 using any other suitable communication channel (e.g., email, text message, messaging service, physical mail service, etc.). As another example, the offer to redeem a gift may be presented at a particular point in the interaction between the user an the provider system 104 (e.g., upon completion of a purchase, at a landing page, after payment of a bill, etc.).

In one or more embodiments, the gifting service system 106 includes a machine learning system 114. The machine learning system 114 may be implemented on one or more computing devices of the gifting service system 106, such as the computing device 1102 described herein at least in connection with FIG. 11, or any portion of such computing devices. Additionally or alternatively, the machine learning system 114 may be implemented as an application or other executable process on one or more computing devices of the gifting service system 106.

In one or more embodiments, the one or more gifts to be offered to the user are determined via a gift options algorithm 116 of the machine learning system 114 of the gifting service system 106. The gift options algorithm 116 may be implemented on one or more computing devices of the gifting service system 106, such as the computing device 1102 described herein at least in connection with FIG. 11, or any portion of such computing devices. Additionally or alternatively, the gift options algorithm 116 may be implemented as an application or other executable process on one or more computing devices of the gifting service system 106. The gift options algorithm 116 may be invoked to determine gift options at the time the decision is made by the reward offer algorithm 118 to provide an offer to redeem a gift to a user, or any time thereafter (e.g., when the user selects to begin a gift redemption process). As used herein, a gift may be any item or service. Examples include, but are not limited to, a physical item, a gift card, a coupon, a service, etc.

In one or more embodiments, the gift options algorithm 116 analyzes user information from the user information store 112 and/or product information from the product information store 110 in order to determine which one or more gift options to provide to the user. As an example, the analysis may include determining that the user is interested in a particular brand, which is associated with one or more provider products and/or partner products that are to be offered as gifts. As another example, the analysis may include determining that the user made a purchase above a certain price, or within a certain price range, and that one or more particular gifts are to be offered with purchases having the price paid by the user. As another example, the analysis may include determining the date on which the user interacted with the provider system 104, and that one or more gift options are to be offered after interactions within a data range that the interaction date is within. As another example, the analysis may include evaluating inventory information to determine what one or more gifts exist in the inventory of the provider or partner of the provider that are to be offered as gifts to users that qualify as best customers of the provider. In one or more embodiments, all or any portion of the aforementioned example analyses may be performed by the gift options algorithm 116 in combination to determine what one or more gift options should be presented to the user.

In one or more embodiments, the gift options algorithm 116 may be or include a machine learning model that is trained to determine what one or more gifts should be presented to the user. As an example, such a machine learning model may use information from product information and/or user information in order to predict what potential gift options are more likely to result on the user electing to redeem a gift. In such a scenario, a provider may have a goal of increasing customer satisfaction with the provider, raising engagement levels, inducing more interaction with the user, etc. To that end, the machine learning model may be trained to predict which one or more particular gifts of the currently available gift options, when presented to the user, are more likely to cause the consumer to decide to redeem the gift.

As an example, the trained gift option machine learning model may be trained to determine that consumers having certain demographic characteristics, living in a certain geographic region, and that made a purchase of a particular brand, and that have been associated with the provider for more than a certain length of time are more likely to select to redeem the gift when a certain type of gift option is presented to the user. The machine learning model may be dynamically updated via continuous training over time to improve its predictive accuracy by adding product information and/or user information, the gift options presented in the offer or other offers for similar users, the results of whether the offer resulted in the redeeming of a gift, the acceptance of the gift by the user, and whether the user redeeming the gift exhibited desired behavior after the redemption, to the training data set for the machine learning model, thereby allowing the machine learning model to better predict gift options that are more likely to result in the redeeming of a gift.

Other machine learning techniques may be used as part of the gift options algorithm 116 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the product information and/or user information associated with or existing at the time of a given user interaction with the provider system 104 had characteristics similar to other users and/or gifts for which an offer to redeem a gift was made and resulted in the outcome(s) desired by the provider.

In one or more embodiments, the user may choose not to redeem a gift by not selecting the interactive element included with the reward notification to begin the process of redeeming the gift, in which case no gift options will be presented to the user, and no gift will be sent to the user. In one or more embodiments, if the user elects to redeem a gift by interacting with the interactive element included with the reward notification (e.g., selecting the button, clicking a text hyperlink, scanning the QR code, etc.), which may be referred to as making a reward redemption request, the gifting service system 106 may provide gift options to the user device 102.

In one or more embodiments, to provide the gift options, the gifting service system may direct the user device to a user interface (i.e., a webpage, mobile application screen, etc.) generated by the gifting service system 106. The user interface may include a presentation of a gift, such as an image, name, description, etc. of the gift. If there is more than one option of what gift may be received, the user interface may include a presentation of the various options via images, names, and/or descriptions of the gifts and a request to select from among the options (e.g., “What gift would you like to receive?”).

The gift options may include any other information without departing from the scope of embodiments described herein. As an example, the gift options may include an image of virtual gift wrapping, and an interactive element that, when selected by the user, reveals (e.g., “unwraps”) the gift. The interactive element may include a signal indicating to the user to select the interactive element to begin the gift redemption process (e.g., “SEE YOUR GIFT”) As another example, the gift options may include explanatory information that provides the user with various details related to the receipt of the gift (e.g., “You have received a gift. To redeem your gift, select the button above, and provide your address to have your gift shipped to you”). As another example, the gift options may include information that provides the user with other details about the gift redemption process (e.g., that the recipient will have the option to exchange the gift for another gift, that the recipient will have the option to select certain customization options related to the gift, etc.).

In one or more embodiments, the one or more gift options presented to the user may depend on when the consumer selects to send a gift (i.e., the timing of the selection to send the gift). As an example, the provider system 104 may transmit the offer to redeem a gift (e.g., the reward notification) in the form of an email. In such a scenario, the user may not immediately open the email, or may open the email but not immediately select to redeem the gift. Thus, the one or more gift options that would be presented to the user may have changed since the time that the reward notification was sent. For example, some or all of the gift options that would have been presented if the user had elected to send a gift near the time that the offer was sent may no longer be available (e.g., there were 1000 partner gifts, but all have already been sent). Therefore, the gift options algorithm 116 may be invoked (possibly again) at the time the user selects to redeem the gift in order to determine gift options that are available at the time of the redemption selection to be presented to the user.

The gift options user interface may also provide various options to the user. Such options may include, but are not limited to, the option to accept the gift offered, or to exchange the gift for another gift from the provider or a partner of the provider. The user interface may include one or more alternate gifts that the user could choose to exchange for the one or more gifts selected by the gift options algorithm 116. The alternate gifts may be presented using an image, a name, and/or details of the one or more alternate gifts.

In one or more embodiments, the user interface presenting the one or more gift options to the user includes an interactive element (e.g., a button, link, etc.) that, when selected (after selecting a gift if more than one is offered), navigates the user to another user interface where additional information is requested from the user. The user interface may include any number of different requests for information from the user. As an example, the page may request that the consumer select a communication channel (e.g., email, text, messenger service, printed mail delivery, etc.) through which the consumer wants to receive information related to the gift. As another example, the page may include a request for a user identifier. The user identifier may include a preferred name of the user, as well as information that facilitates the gifting service system 106 to interact with the user via the user's selected communication channel (e.g., an email address, a phone number, etc.).

The user interface may also include an interactive element that, when selected, allows the user to continue the gift redemption process. The interactive element may change, depending on other selections made by the user. For example, the interactive element may be a button that, when selected by the user, navigates the user to another portion of the user interface to continue the gift redemption process. The interactive element may include a signal indicating to the user to select the interactive element to continue the process. The signal may, for example, be text, which may change based on other selections of the user. As an example, the text may state “Continue” if the recipient checks a check element on the page indicating that they would prefer to continue with the one of the gifts presented in the gift options, but change to “Exchange this gift” if the user checks a check element indicating that they would prefer to exchange the gift for an alternate gift. In one or more embodiments, if the user makes a selection indicating that the user wants to exchange the gift, then the elements on the user interface presenting the one or more alternate gift options may be selectable to allow the user to indicate which alternate gift the user prefers. In such a scenario, the page may also include an indication to the user that the user should select from among the alternate gift options.

In one or more embodiments, the alternate gift options presented to the user are determined by the gift options algorithm 116. As an example, the gift options algorithm 116 may include a predictive machine learning model that takes is provided with the rejection of the gift options, and used to predict the one or more alternate gifts.

In one or more embodiments, once the user has selected a gift, the user may be presented with various customization options (e.g., size, color, etc.) and requests for information (e.g., address to send the gift to, preferred delivery options, etc.). The collective information that includes selected gift, gift customization selections, address, preferred delivery options, preferred communication channel, user identifier, etc. may be referred to as redemption information. The redemption information may be transmitted from the user device 102 to the gifting service system 106.

Although the above description contemplates various presentations and user interface portions provided to the recipient to complete the gift redemption process, all or any portion of the presentations may be combined into a single user interface portion, or divided differently into separate user interface portions, without departing from the scope of embodiments described herein. As such, in one or more embodiments, the redemption information may be transmitted to the gifting service system 106 as a single transmission, or as a series of transmissions.

In one or more embodiments, once the recipient has made all necessary selections and provided the requested information (which may be referred to collectively as redemption information), the redemption information is transmitted from the user device 102 to the gifting service system 106. In one or more embodiments, based at least in part on the redemption information, the gifting service system 106 initiates delivery of the selected gift to the user. The method of delivery may be based on a selection made by the user during the gift redemption process by which the user indicated a preferred method of delivery. As an example, the gift may be a gift card, and the user may have selected to receive the gift card as a virtual gift card delivered via email. As another example, the gift may be a physical object, and the user may have provided a physical address to which the gift is shipped. The gifting service system 106 may perform the delivery of the gift. Additionally or alternatively, the gifting service system 106 may provide information related to the planned delivery to the provider system 104 and/or the partner system, and the provider system 104 and/or partner system may perform the delivery of the gift to the user. In one or more embodiments, regardless of which entity performs the delivery of the gift, information related to the user may be provided to the provider system 104 and/or to the partner system(s), thereby providing the provider and/or partner(s) with information including that a gift was redeemed by the user, what the gift was, and/or any other information obtained during the gift redemption process. In one or more embodiments, all or any portion of any information obtained related to the user during the gift redemption process is used by the gifting service system 106 to dynamically update historical data maintained by the gifting service system 106, which may be used to dynamically update the machine learning models of the reward offer algorithm 118 and/or the gift options algorithm 116 by adding the obtained information in real-time to the training data sets for the machine learning models.

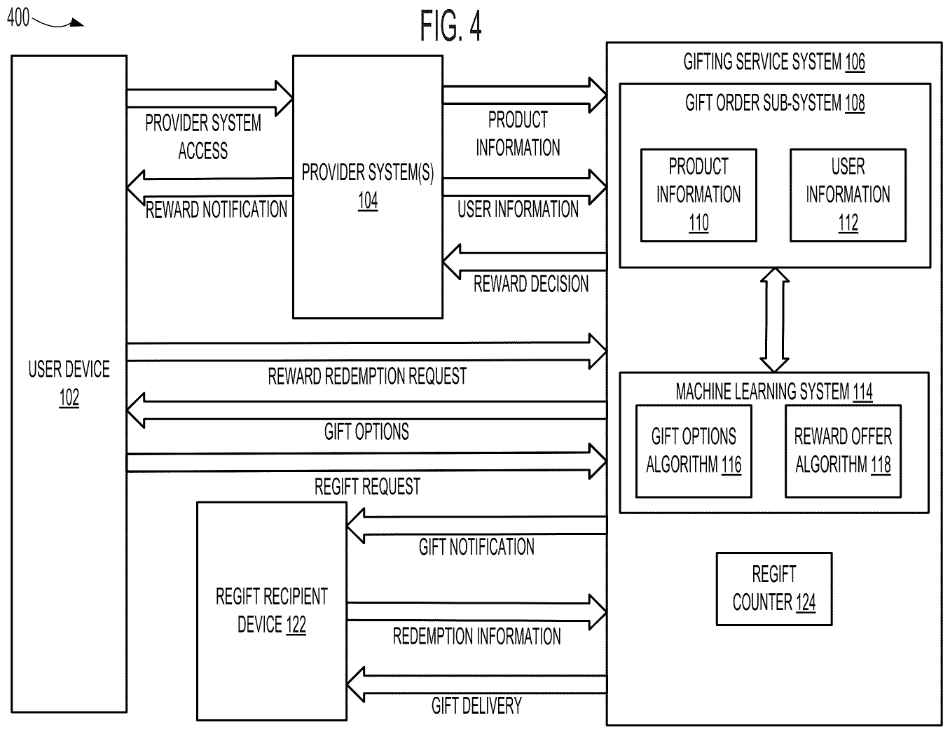

FIG. 4 shows an illustrative example of an environment 400 in which a user device 102 interacts with a provider system 104. The user device 102 may be a computing device such as the computing device 1102 described herein at least in connection with FIG. 11. The computing device may be, for example, a laptop computer, a desktop computer, a smartphone, a tablet, a smart watch, or any other type of computing device such as those described herein. As another example, a user may interact with a provider at a physical retail establishment, and the user device 102 may be a device provided by the retail establishment (i.e., as a point-of-sale service) to allow the user to interact with the provider. In one or more embodiments, the user device communicates with the provider system 104 over a network (not shown) such as the network 1122 described herein at least in connection with FIG. 11. The provider system 104 may be one or more computing devices such as the computing device 1102 described herein at least in connection with FIG. 11. As an example, the provider system 104 may be one or more server computing devices controlled or otherwise used by a provider (not shown). In one or more embodiments, a provider is any entity that offers for sale or otherwise provides any number of products (e.g., goods and/or services).

As an example, a user may use a browser application (not shown) or other application (not shown) of the user device 102 to peruse product offerings of a provider associated with the provider system 104, to access an account that the user has with the provider, etc. While the user accesses various webpages, online account management portals, or other channels that are offering product(s) of the provider and/or providing the ability for the user to interact with the provider (e.g., account management), certain user interface screens may be accompanied by options to redeem a gift presented as a user interface element (e.g., a box that includes text such as “Thanks for being one of our best customers” and an interactive user interface element (e.g., a button) that includes text such as “Redeem your gift”). A gift may be any item, such as a good, service, gift card, coupon, experience opportunity (e.g., travel, dining, etc.), etc. Other items may be considered gifts without departing from the scope of embodiments described herein.

In one or more embodiments, the environment 400 differs from the environment 100 shown in FIG. 1, the environment 200 shown in FIG. 2, and the environment 300 shown in FIG. 3 in that the user associated with the user device 102 may be presented with an alternate gift redemption option to regift the offered gift to a regift recipient device 122.

In one or more embodiments, whether or not an option to redeem a gift is presented to a user may be determined by a reward offer algorithm 118 of a gifting service system 106. The determination may be triggered via the user device 102 accessing the provider system 104. Additionally or alternatively, the determination may be triggered prior to the access based on a request from the provider system 104 to the gifting service system 106. As an example, the provider system 104 may be associated with a service provider, such as a credit card service provider, and the provider may choose to engage the gifting service system 106 to determine whether the user qualifies as a best customer and, if so, be presented with an option to redeem a gift, which may occur when or before a user accesses the provider system 104 associated with the provider.

The gifting service system 106 may be one or more computing devices such as the computing device 1102 described herein at least in connection with FIG. 11. As an example, the gifting service system 106 may be one or more server computing devices controlled or otherwise used by a gifting service provider (not shown). In one or more embodiments, the gifting service system 106 is configured to provide gifting services, which may be any number of ways to provide users, consumers, businesses, etc. with the ability to offer gifts in a variety of ways for a variety of purposes.

In one or more embodiments, the provider system 104 may provide product information and/or user information to gifting service system 106. In one or more embodiments, the gifting service system 106 includes a provider sub-system 108. The provider sub-system 108 may be one or more computing devices such as the computing device 1102 described herein at least in connection with FIG. 11, or any portion of such computing devices. In one or more embodiments, the provider sub-system 108 includes a datastore (not shown) that stores any data received from or otherwise obtained and related to the provider associated with provider system 104. As such, the provider sub-system 108 may store all or any portion of the product information (described below) received from the provider system 104, all or any portion of any user information (described below) received from the provider system 104 or otherwise obtained by the gifting service system 106.

In one or more embodiments, the product information is stored in a product information store 110 of the provider sub-system 108. The product information store 110 may be one or more computing devices such as the computing device 1102 described herein at least in connection with FIG. 11, or any portion of such computing devices (e.g., data storage for storing one or more data structures that include the product information). In one or more embodiments, the product information store 110 includes a datastore for storing any information related to products associated with the provider system 104, organized in any suitable one or more data structures, that may be offered as gifts to users.

In one or more embodiments, product information, provided from the provider system 104 to the gifting service system 106, may be any information related to any product that may be offered by the provider system 104 as a gift to a user for which a determination was made that the user qualifies to be provided with an option to redeem a gift (e.g., for being a “best customer” of the provider). Such product information may be stored in the product information store 110 of the provider sub-system 108 of the gifting service system 106. The product information may include, for example, names of products, identifiers of products, information about products (e.g., size options, color options, style options, etc.), images of products, etc. As another example, the product information may include categorization information defining what one or more categories of products that a given product of the provider is in. As another example the product information may include product pricing information. As another example, the product information may include identification of products that a provider wants to be offered to a user when a determination is made to present the user with an option to redeem a gift (e.g., for qualifying as a “best customer” of the provider). As another example, the product information may include identification of one or more specific gifts. For example, product information may include information indicating that a specific brand of products should be associated with one or more gift options that may be offered to a user. As another example product information may include information related to inventory levels of one or more products of a provider and/or of one or more gift options that may be offered to a user when a determination is made to provide the user with an opportunity to redeem a gift. Product information may be dynamically updated in real time. As an example, a provider or partner of a provider may provide updated and/or new product information from time to time, which may be used to dynamically update the product information in the product information store 110.

In one or more embodiments, a provider system 104 may be associated with one or more partner systems (not shown). A partner system may be one or more computing devices such as the computing device 1102 described herein at least in connection with FIG. 11. In one or more embodiments, a partner system is associated with a partner of the provider associated with the provider system 104. In one or more embodiments, a partner is any entity that has a relationship with the provider. As an example, a partner may be another provider or other entity that offers products (e.g., goods and/or services). In one or more embodiments, a partner may desire to provide its products as gifts to users identified as best customers relative to the provider system 104. For example, a partner may be seeking to gain customers for its products. To that end, the partner may enter into an agreement with the provider such that the provider will offer one or more products of the partner as gifts when a user qualifies as a best customer of the provider. As an example, the partner may seek to have the provider offer one or more partner products as gifts to users that qualify as best customers within a certain timeframe. As another example, the partner may seek to have the provider offer one or more products of the partner to users that purchase one or more products from the provider and are associated with certain characteristics (e.g., have certain demographic characteristics, spent above a certain amount on the purchase, etc.). In one or more embodiments, in order for one or more partner products to be offered as gifts to users, the partner system may provide product information. Such product information may be provided to the provider system 104. The provider system 104 may, in turn, provide the partner product information to the gifting service system 106 (as described above) as part of the product information provided by the provider system 104. Additionally or alternatively, the partner system may provide the partner product information to the gifting service system 106, and such product information may be stored in the product information store 110.

In one or more embodiments, the provider sub-system 108 includes a user information store 112. The user information store 112 may be one or more computing devices such as the computing device 1102 described herein at least in connection with FIG. 11, or any portion of such computing devices (e.g., data storage for storing one or more data structures that include user information). In one or more embodiments, the user information store 112 includes a datastore for storing any information related to users associated with the provider system 104, organized in any suitable one or more data structures.

User information stored in the user information store 112 may be obtained from the user information received from the provider system 104. Such information may further include any information about users obtained by the gifting service system 106 obtained from any other source for any other purpose. As an example, the gifting service system 106 may have interacted with the user previously (e.g., for redeeming a previous gift, providing gifting services, etc.) and obtained information about the user through the interaction. As another example, user information stored in the user information store 112 may include data related to users obtained via various online sources (e.g., cookies, clickstream data, search data, purchase data, user profile data, etc.), data corresponding to content presented on a website or application (e.g., dates, product details, images, videos, other advertisements, comments, news stories and headlines, etc.), data obtained from e-mails or social media posts/comments/profiles, etc.

In one or more embodiments, user information provided from the provider system 104 to the gifting service system 106 may include information related to the user for which the provider system 104 is seeking a determination as to whether the user qualifies to be provided with an option to redeem a gift (e.g., qualifies as a “best customer”). Such user information may include any information related to or otherwise associated with the user for which such a determination is requested. For example, the consumer may have created an account with the provider, and the provider system 104 may maintain a user profile associated with the user. All or any portion of the information maintained in such a user profile may be provided to the gifting service system 106 as part of the user information. As another example, the provider system 104 may provide information related to any number of users to the gifting service system 106 as user information. User information may include any information about a user such as, for example, demographic information (e.g., name, age, location, etc.), purchase and/or interaction history with the provider, length of time of the relationship between the provider and the user, one or more date ranges of interactions between the user and the provider system 104, etc., which may be obtained by the gifting service system 106 from a provider, and/or sources other than the provider system 104 (e.g., previous interactions with a user, cookies, browser extensions, social media platforms, etc.). User information related to a particular user and/or to one or more groups of users may be referred to as historical user information. In one or more embodiments, historical user information is dynamically updated in real-time. As an example, updates may be added to the historical user information as users make purchases from or otherwise interact with providers, decide whether or not to redeem gifts, make changes to social media profiles, update provider account profiles, etc.

In one or more embodiments, the gifting service system 106 includes a machine learning system 114. The machine learning system 114 may be implemented on one or more computing devices of the gifting service system 106, such as the computing device 1102 described herein at least in connection with FIG. 11, or any portion of such computing devices. Additionally or alternatively, the machine learning system 114 may be implemented as an application or other executable process on one or more computing devices of the gifting service system 106.

The machine learning system 114 may include a reward offer algorithm 118 that is configured to analyze user information stored in the user information store 112 in order to determine whether a user should be provided an offer to redeem a gift (e.g., whether the user qualifies as a “best customer” of the provider). The reward offer algorithm 118 may be implemented on one or more computing devices of the gifting service system 106, such as the computing device 1102 described herein at least in connection with FIG. 11, or any portion of such computing devices. Additionally or alternatively, the reward offer algorithm 118 may be implemented as an application or other executable process on one or more computing devices of the gifting service system 106.

In one or more embodiments, the reward offer algorithm 118 is invoked by the gifting service system 106 in response to receiving or otherwise obtaining or determining a request from the provider system 104 indicating that the provider system seeks a determination as to whether a particular user qualifies to receive an option to redeem a gift (e.g., qualifies as a best customer). Such a request may be made, for example, when the user device 102 accesses the provider system 104. Additionally or alternatively, the request may be made at any other time, such that the provider system is prepared to offer an option to redeem a gift to a qualified user the next time the user device 102 accesses the provider system 104.

The reward offer algorithm 118 may include any number of rules to be evaluated in order to determine whether a user qualifies to receive an offer to redeem a gift. The reward offer algorithm 118 may include rules that associate certain characteristics of a user with a determination as to whether the user qualifies as a best customer (e.g., qualifies to receive an offer to redeem a gift). Examples of such characteristics include, but are not limited to, length of time the user has been associated with the provider system 104, certain actions taken by the user (e.g., paid a bill, spent a certain amount, etc.), user demographic information, date range of an interaction between the user and the provider system 104, a user's interest level in a particular holiday, etc. As an example, the reward offer algorithm 118 may include rules that indicate that a user in a certain geographic region, that has been associated with the provider for more than a certain amount of time, and that has spent a certain amount with the provider over a given period of time qualifies as a best customer and, as such, qualifies to receive an offer to redeem a gift. In one or more embodiments, the above-described rules, and/or any other such rules, may be evaluated by the reward offer algorithm 118 in any combination to determine whether a given user qualifies to be provided with an option to redeem a gift.

In one or more embodiments, the reward offer algorithm 118 may be or include a machine learning model that is trained to determine whether a given user qualifies to receive an offer so receive an option to redeem a gift as a reward (e.g., for being a best customer). Such a machine learning model may use any user information in order to predict whether a given user qualifies to receive an offer to redeem a gift.

As an example, a provider may have a goal of improving user engagement by offering a gift to the best customers of the provider, and is seeking to offer a gift to the best 50,000 customers. To that end, the machine learning model may be trained to predict the likelihood that providing the offer to redeem a gift to a particular user will result in the user maintaining or increasing an engagement level with the provider, and only users with a likelihood over a defined threshold should receive such an offer. The machine learning model may be dynamically updated via continuous training over time to improve its predictive accuracy by adding user information, along with the result of whether the offer resulted in the redeeming of the gift and whether the user maintained or increased engagement with the retailer, to the training data set for the machine learning model, thereby allowing the machine learning model to better predict the likelihood that providing a user with an offer to redeem a gift will result in better engagement by the user with the provider.

Other machine learning techniques may be used as part of the reward offer algorithm 118 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the user information associated with a given user include characteristics similar to other users for which an offer to redeem a gift was made and resulted in the desired outcome of the provider.

In one or more embodiments, using user information, in response to receiving a request from the provider system 104 upon a user accessing the provider system 104, the reward offer algorithm 118 analyzes the user information (as described above) and generates a reward decision. In one or more embodiments, a reward decision is a decision as to whether or not a user should be presented with an offer to redeem a gift (e.g., for qualifying as a best customer of the provider). In one or more embodiments, the gifting service system 106 transmits the reward decision to the provider system 104. Additionally or alternatively, in one or more embodiments, the reward offer algorithm 118 may be invoked, as described above, before user interacts with the provider system 104. In such a scenario, the provider system 104 may be prepared to present the reward to the user at the time the user next accesses the provider system 104. In either scenario, the provider, via the provider system 104, may present a reward notification to the user via the user device 102.

The reward notification may be provided using any suitable technique for alerting the user that the user has received an option to redeem a gift. As an example, while the user is navigating a user interface (e.g., a website, mobile application etc.) of the provider system 104, a user interface element that includes an interactive user interface element (e.g., a button, a link, a quick response (QR) code, etc.) that informs the user that they have been selected to redeem a gift and to interact with the interactive user interface element to begin the redemption process. As another example, the reward notification may be transmitted to the user device 102 using any other suitable communication channel (e.g., email, text message, messaging service, etc.). As another example, the offer to redeem a gift may be presented at a particular point in the interaction between the user an the provider system 104 (e.g., upon completion of a purchase, at a landing page, after payment of a bill, etc.).

In one or more embodiments, the one or more gifts to be offered to the user are determined via a gift options algorithm 116 of the machine learning system 114 of the gifting service system 106. The gift options algorithm 116 may be implemented on one or more computing devices of the gifting service system 106, such as the computing device 1102 described herein at least in connection with FIG. 11, or any portion of such computing devices. Additionally or alternatively, the gift options algorithm 116 may be implemented as an application or other executable process on one or more computing devices of the gifting service system 106. The gift options algorithm 116 may be invoked to determine gift options at the time the decision is made by the reward offer algorithm 118 to provide an offer to redeem a gift to a user, or any time thereafter (e.g., when the user selects to begin a gift redemption process). As used herein, a gift may be any item or service. Examples include, but are not limited to, a physical item, a gift card, a coupon, a service, etc.

In one or more embodiments, the gift options algorithm 116 analyzes user information from the user information store 112 and/or product information from the product information store 110 in order to determine which one or more gift options to provide to the user. As an example, the analysis may include determining that the user is interested in a particular brand, which is associated with one or more provider products and/or partner products that are to be offered as gifts. As another example, the analysis may include determining that the user made a purchase above a certain price, or within a certain price range, and that one or more particular gifts are to be offered with purchases having the price paid by the user. As another example, the analysis may include determining the date on which the user interacted with the provider system 104, and that one or more gift options are to be offered after interactions within a data range that the interaction date is within. As another example, the analysis may include evaluating inventory information to determine what one or more gifts exist in the inventory of the provider or partner of the provider that are to be offered as gifts to users that qualify as best customers of the provider. In one or more embodiments, all or any portion of the aforementioned example analyses may be performed by the gift options algorithm 116 in combination to determine what one or more gift options should be presented to the user.

In one or more embodiments, the gift options algorithm 116 may be or include a machine learning model that is trained to determine what one or more gifts should be presented to the user. As an example, such a machine learning model may use information from product information and/or user information in order to predict what potential gift options are more likely to result on the user electing to redeem a gift. In such a scenario, a provider may have a goal of increasing customer satisfaction with the provider, raising engagement levels, inducing more interaction with the user, etc. To that end, the machine learning model may be trained to predict which one or more particular gifts of the currently available gift options, when presented to the user, are more likely to cause the consumer to decide to redeem the gift.

As an example, the trained gift option machine learning model may be trained to determine that consumers having certain demographic characteristics, living in a certain geographic region, and that made a purchase of a particular brand, and that have been associated with the provider for more than a certain length of time are more likely to select to redeem the gift when a certain type of gift option is presented to the user. The machine learning model may be dynamically updated via continuous training over time to improve its predictive accuracy by adding product information and/or user information, the gift options presented in the offer or other offers for similar users, the results of whether the offer resulted in the redeeming of a gift, the acceptance of the gift by the user, and whether the user redeeming the gift exhibited desired behavior after the redemption, to the training data set for the machine learning model, thereby allowing the machine learning model to better predict gift options that are more likely to result in the redeeming of a gift.

Other machine learning techniques may be used as part of the gift options algorithm 116 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the product information and/or user information associated with or existing at the time of a given user interaction with the provider system 104 had characteristics similar to other users and/or gifts for which an offer to redeem a gift was made and resulted in the outcome(s) desired by the provider.

In one or more embodiments, the user may choose not to redeem a gift by not selecting the interactive element included with the reward notification to begin the process of redeeming the gift, in which case no gift options will be presented to the user, and no gift will be sent to the user. In one or more embodiments, if the user elects to redeem a gift by interacting with the interactive element included with the reward notification (e.g., selecting the button, clicking a text hyperlink, scanning the QR code, etc.), which may be referred to as making a reward redemption request, the gifting service system 106 may provide gift options to the user device 102.

In one or more embodiments, to provide the gift options, the gifting service system may direct the user device to a user interface (i.e., a webpage, mobile application screen, etc.) generated by the gifting service system 106. The user interface may include a presentation of a gift, such as an image, name, description, etc. of the gift. If there is more than one option of what gift may be received, the user interface may include a presentation of the various options via images, names, and/or descriptions of the gifts and a request to select from among the options (e.g., “What gift would you like to receive?”).

The gift options may include any other information without departing from the scope of embodiments described herein. As an example, the gift options may include an image of virtual gift wrapping, and an interactive element that, when selected by the user, reveals (e.g., “unwraps”) the gift. The interactive element may include a signal indicating to the user to select the interactive element to begin the gift redemption process (e.g., “SEE YOUR GIFT”) As another example, the gift options may include explanatory information that provides the user with various details related to the receipt of the gift (e.g., “You have received a gift. To redeem your gift, select the button above, and provide your address to have your gift shipped to you”). As another example, the gift options may include information that provides the user with other details about the gift redemption process (e.g., that the recipient will have the option to exchange the gift for another gift, that the recipient will have the option to select certain customization options related to the gift, etc.).

In one or more embodiments, the one or more gift options presented to the user may depend on when the consumer selects to send a gift (i.e., the timing of the selection to send the gift). As an example, the provider system 104 may transmit the offer to redeem a gift (e.g., the reward notification) in the form of an email. In such a scenario, the user may not immediately open the email, or may open the email but not immediately select to redeem the gift. Thus, the one or more gift options that would be presented to the user may have changed since the time that the reward notification was sent. For example, some or all of the gift options that would have been presented if the user had elected to send a gift near the time that the offer was sent may no longer be available (e.g., there were 1000 partner gifts, but all have already been sent). Therefore, the gift options algorithm 116 may be invoked (possibly again) at the time the user selects to redeem the gift in order to determine gift options that are available at the time of the redemption selection to be presented to the user.

The gift options user interface may also provide various options to the user. Such options may include, but are not limited to, the option to accept the gift offered, or to exchange the gift for another gift from the provider or a partner of the provider. The user interface may include one or more alternate gifts that the user could choose to exchange for the one or more gifts selected by the gift options algorithm 116. The alternate gifts may be presented using an image, a name, and/or details of the one or more alternate gifts.

In one or more embodiments, the user interface presenting the one or more gift options to the user includes an interactive element (e.g., a button, link, etc.) that, when selected (after selecting a gift if more than one is offered), navigates the user to another user interface where additional information is requested from the user. The user interface may include any number of different requests for information from the user. As an example, the page may request that the consumer select a communication channel (e.g., email, text, messenger service, printed mail delivery, etc.) through which the consumer wants to receive information related to the gift. As another example, the page may include a request for a user identifier. The user identifier may include a preferred name of the user, as well as information that facilitates the gifting service system 106 to interact with the user via the user's selected communication channel (e.g., an email address, a phone number, etc.).

The user interface may also include an interactive element that, when selected, allows the user to continue the gift redemption process. The interactive element may change, depending on other selections made by the user. For example, the interactive element may be a button that, when selected by the user, navigates the user to another portion of the user interface to continue the gift redemption process. The interactive element may include a signal indicating to the user to select the interactive element to continue the process. The signal may, for example, be text, which may change based on other selections of the user. As an example, the text may state “Continue” if the recipient checks a check element on the page indicating that they would prefer to continue with the one of the gifts presented in the gift options, but change to “Exchange this gift” if the user checks a check element indicating that they would prefer to exchange the gift for an alternate gift. In one or more embodiments, if the user makes a selection indicating that the user wants to exchange the gift, then the elements on the user interface presenting the one or more alternate gift options may be selectable to allow the user to indicate which alternate gift the user prefers. In such a scenario, the page may also include an indication to the user that the user should select from among the alternate gift options.

In one or more embodiments, the alternate gift options presented to the user are determined by the gift options algorithm 116. As an example, the gift options algorithm 116 may include a predictive machine learning model that takes is provided with the rejection of the gift options, and used to predict the one or more alternate gifts.

In one or more embodiments, once the user has selected a gift, the user may be presented with various customization options (e.g., size, color, etc.) and requests for information (e.g., address to send the gift to, preferred delivery options, etc.). The collective information that includes selected gift, gift customization selections, address, preferred delivery options, preferred communication channel, user identifier, etc. may be referred to as redemption information. The redemption information may be transmitted from the user device 102 to the gifting service system 106.

In one or more embodiments, a user may not want or need a gift provided by the provider for being a best customer, or may desire to provide the gift to another. In such scenarios, the user interface provided may include one or more additional interactive elements that provide alternate redemption options. Such alternate redemption options may include, for example, an option to regift the gift to a regift recipient device 122. In one or more embodiments, whether or not a regift option is provided to the user may be determined by the gift options algorithm 116.

Although the above description contemplates various presentations and user interface portions provided to the recipient to complete the gift redemption process, all or any portion of the presentations may be combined into a single user interface portion, or divided differently into separate user interface portions, without departing from the scope of embodiments described herein. As such, in one or more embodiments, the redemption information may be transmitted to the gifting service system 106 as a single transmission, or as a series of transmissions.

In one or more embodiments, when a user uses an interactive element to indicate a desire to regift a gift to a regift recipient device 122, the indication, which may be referred to as a regift request, is transmitted from the user device 102 to the gifting service system 106. In one or more embodiments, the transmission of the regift request initiates a regift process. In one or more embodiments, the regift process includes the gifting service system 106 requesting various items of information from the user, which may be presented as one or more user interface portions transmitted to the user device 102. Each user interface portion may request all or any portion of the information necessary to regift the gift.

As an example, the regift information request may be presented to the user device 102 as a series of user interface portions that request that the user associated with the user device 102 provide the name of the intended regift recipient device 122, a communication channel through which the regift recipient device 122 may be notified of the regift, contact information based on the communication channel selected (e.g., email address when email is the communication channel, phone number when text message is the communication channel, etc.), updated virtual gift wrapping options, updated personalization options (e.g., the name of the user that is regifting the gift, a message for the regift recipient device 122, etc.). In one or more embodiments, other options may be presented to the user during the regift process. As an example, the user may be presented with an option to add to the gift, such as by adding additional funds when the gift is a gift card. As another example, the gifting service system 106 may present additional gift options determined by the gift options algorithm 116 as suggestions to add to the gift (e.g., when the gift is a belt, an option to send a hat with the belt for an additional cost). As another example, the user may be given an option to swap the intended gift for any number of possible alternate gift options (e.g., that are generated by the gift options algorithm 116).

In one or more embodiments, the set of information provided by the user during the regift process, which may collectively be referred to as regift information, is transmitted from the user device 102 to the gifting service system 106. In one or more embodiments, after receiving the regift information, the gifting service system 106 increments a regift counter 124. In one or more embodiments, the regift counter 124 is hardware, software, or any combination thereof that includes functionality to track a quantity of instances that a gift has been regifted. In one or more embodiments, the user may be presented with an opportunity to indicate a maximum number of allowed times that a gift may be regifted. Alternatively, the gifting service system 106 may include a pre-determined or configurable maximum number of allowed times that a gift may be regifted. In one or more embodiments, whether a gift has reached the maximum number of regift instances is tracked, at least in part, by the regift counter 124.

As an example, the regift counter 124 may be a counter that is incremented each time a gift is regifted (e.g., when a recipient indicates a desire to regift a gift and provides regift information). In such a scenario, the gifting service system 106 may include logic for checking the regift counter to determine if the maximum number of allowed regifts has been reached (e.g., the regift counter 124 has been incremented such that it stores a value equal the maximum allowed number of regifts) and, if so, not present a regift option to the next regift recipient. As another example, the regift counter 124 may be configured with the maximum number of allowed regifts, and decremented each time a regift occurs. In such a scenario, the gifting service system may include logic for checking the regift counter to determine if the maximum number of allowed regifts has been reached (e.g., the regift counter 124 has reached zero) and, if so, not present a regift option to the next regift recipient.

In one or more embodiments, after receiving the regift information from the user device 102, the gifting service system 106 may generate a gift notification. The gift notification may be transmitted by the gifting service system 106 to a regift recipient device 122 associated with the intended regift recipient (not shown). The regift recipient device 122 may be implemented on one or more computing devices, such as the computing device 1102 described herein at least in connection with FIG. 11.

In one or more embodiments, the gift notification is transmitted to the regift recipient device 122 using a communication channel selected by the user associated with the user device 102, which may include using at least a portion of the regift recipient information provided by the user. For example, if email was selected as the communication channel, the gift notification may be transmitted using an email address of the regift recipient provided by the user. As another example, if text message was selected as the communication channel, then a phone number of the regift recipient associated with the regift recipient device 122 may be used to send the gift notification.

In one or more embodiments, the gift notification includes an indication that the regift recipient has been sent a gift. The gift notification may not include an indication that the gift is a regift. The indication may or may not identify the user as the sender of the gift (e.g., “Kelly got you a gift!”). The gift notification may include any other information without departing from the scope of embodiments described herein. As an example, the gift notification may include an image of virtual gift wrapping, and an interactive element that, when selected by the regift recipient, reveals (e.g., “unwraps”) the gift. The interactive element may include a signal indicating to the recipient to select the interactive element to begin the gift redemption process (e.g., “SEE YOUR GIFT”) As another example, the updated gift notification may include explanatory information that provides the regift recipient with various details related to the receipt of the gift (e.g., “You have received a gift. To redeem your gift, select the button above, and provide your address to have your gift shipped to you”). As another example, the updated gift notification may include information that provides the regift recipient with other details about the gift redemption process (e.g., that the regift recipient will have the option to exchange the gift for another gift, that the regift recipient will have the option to select certain customization options related to the gift, etc.).

In one or more embodiments, when the regift recipient selects to reveal the gift using the interactive element of the gift notification, the regift recipient may be navigated to a user interface that displays the gift. The display of the gift may include an image of the gift, the name of the gift, details related to the gift, etc. The user interface may also include an interactive element that, when selected continues the gift redemption process, which may be a process by which redemption information is provided from the regift recipient device 122 to the gifting service system 106. The interactive element may include a signal to the regift recipient indicating that the recipient should select the interactive element (e.g., a button) to continue the gift redemption process. For example, the interactive element may include text, such as “REDEEM YOUR GIFT”.

In one or more embodiments, when the regift recipient, via the interactive element on the user interface, selects to continue the gift redemption process, the regift recipient may be navigated to another portion of the user interface generated by the gifting service system 106 that provides various options to the regift recipient. Such options may include, but are not limited to, the option to accept the gift (e.g., the gift selected by the user associated with the user device 102), or to exchange the gift for another gift. The page may include one or more alternate gifts that the regift recipient may choose to exchange for the gift. The alternate gifts may be presented using an image, a name, and/or details of the one or more alternate gifts. The page may also include an image, name, and or details related to the gift that was initially selected by the user (e.g., for the sake of comparison by the regift recipient with the one or more alternate gift options).

The user interface may also include an interactive element that, when selected, allows the regift recipient to continue the gift redemption process. The interactive element may change, depending on other selections made by the regift recipient. For example, the interactive element may be a button that, when selected by the recipient, navigates the regift recipient to another user interface portion to continue the gift redemption process. The interactive element may include a signal indicating to the regift recipient to select the interactive element to continue the process. The signal may, for example, be text, which may change based on other selections of the regift recipient. As an example, the text may state “Continue” if the regift recipient checks a check element on the page indicating that they would prefer to continue with the gift selected by the user, but change to “Exchange this gift” if the regift recipient checks a check element indicating that they would prefer to exchange the gift for an alternate gift. In one or more embodiments, if the regift recipient makes a selection on the page indicating that the regift recipient wants to exchange the gift, then the elements on the user interface presenting the one or more alternate gift options may be selectable to allow the regift recipient to indicate which alternate gift the regift recipient prefers. In such a scenario, the page may also include an indication to the regift recipient that the regift recipient should select from among the alternate gift options.

In one or more embodiments, the alternate gift options presented to the regift recipient are the same as the other gift options that were presented to the user. In other embodiments, the alternate gift options presented to the regift recipient are different from the other gift options that were previously presented to the user. In one or more embodiments, when more than one gift option is presented to the regift recipient (i.e., the gift and one or more alternate gifts), the alternate gifts may be determined by the gift options algorithm 116 of the gifting service system 106.

In one or more embodiments, once the regift recipient has selected to continue with the gift, or selected an alternate gift, the regift recipient may be presented with various customization options (e.g., size, color, etc.) and requests for information (e.g., address to send the gift to, preferred delivery options, etc.), which may be collectively referred to as redemption information. In one or more embodiments, the regift recipient is also optionally presented with an option to send a thank you to the user for the gift.

Although the above description contemplates various presentations and user interface portions provided to the regift recipient to complete the gift redemption process, all or any portion of the presentations and user interface portions may be combined into a single user interface, or divided differently into user interface portions, without departing from the scope of embodiments described herein.

In one or more embodiments, once the regift recipient has made all necessary selections and provided the requested information (which may be referred to collectively as redemption information), the redemption information transmitted from the regift recipient device 122 to the gifting service system 106. In one or more embodiments, based at least in part on the redemption information, the gifting service system 106 initiates delivery of the selected gift to the regift recipient. The method of delivery may be based on a selection made by the regift recipient during the gift redemption process by which the recipient indicated a preferred method of delivery. As an example, the gift may be a gift card, and the regift recipient may have selected to receive the gift card as a virtual gift card delivered via email. As another example, the gift may be a physical object, and the regift recipient may have provided a physical address to which the gift is shipped. The gifting service system 106 may perform the delivery of the gift. Additionally or alternatively, the gifting service system 106 may provide information related to the planned delivery to a third party entity, which may perform the delivery of the gift to the regift recipient.

In one or more embodiments, all or any portion of any information obtained related to the user and/or the regift recipient is used by the gifting service system 106 to dynamically update historical data maintained by the gifting service system 106, which may be used to dynamically update the machine learning models of the reward offer algorithm 118 and/or the gift options algorithm 116 by adding the obtained information in real-time to the training data sets for the machine learning models.

In one or more embodiments, the gift notification, or any subsequent user interface portion presented to the regift recipient, may include an option to regift the gift to another regift recipient (not shown). Whether such an option is presented to the regift recipient may be determined by the gifting service system 106. Such a determination may include determining, using the regift counter 124, whether the regifting of the gift to the regift recipient caused the state of the regift counter 124 to indicate that the maximum number of allowed regifts has been reached.

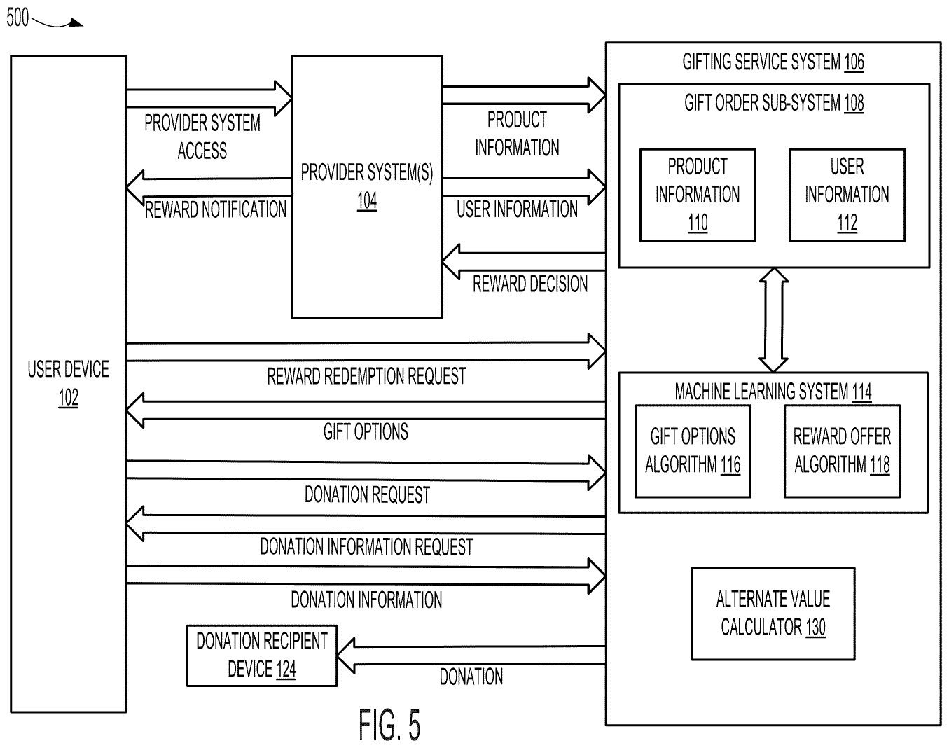

FIG. 5 shows an illustrative example of an environment 500 in which a user device 102 interacts with a provider system 104. The user device 102 may be a computing device such as the computing device 1102 described herein at least in connection with FIG. 11. The computing device may be, for example, a laptop computer, a desktop computer, a smartphone, a tablet, a smart watch, or any other type of computing device such as those described herein. As another example, a user may interact with a provider at a physical retail establishment, and the user device 102 may be a device provided by the retail establishment (i.e., as a point-of-sale service) to allow the user to interact with the provider. In one or more embodiments, the user device communicates with the provider system 104 over a network (not shown) such as the network 1122 described herein at least in connection with FIG. 11. The provider system 104 may be one or more computing devices such as the computing device 1102 described herein at least in connection with FIG. 11. As an example, the provider system 104 may be one or more server computing devices controlled or otherwise used by a provider (not shown). In one or more embodiments, a provider is any entity that offers for sale or otherwise provides any number of products (e.g., goods and/or services).

As an example, a user may use a browser application (not shown) or other application (not shown) of the user device 102 to peruse product offerings of a provider associated with the provider system 104, to access an account that the user has with the provider, etc. While the user accesses various webpages, online account management portals, or other channels that are offering product(s) of the provider and/or providing the ability for the user to interact with the provider (e.g., account management), certain user interface screens may be accompanied by options to redeem a gift presented as a user interface element (e.g., a box that includes text such as “Thanks for being one of our best customers” and an interactive user interface element (e.g., a button) that includes text such as “Redeem your gift”). A gift may be any item, such as a good, service, gift card, coupon, experience opportunity (e.g., travel, dining, etc.), etc. Other items may be considered gifts without departing from the scope of embodiments described herein.

In one or more embodiments, the environment 500 differs from the environment 100 shown in FIG. 1, the environment 200 shown in FIG. 2, and the environment 300 shown in FIG. 3 in that the user associated with the user device 102 may be presented with an alternate gift redemption option to provide the value of the gift as a donation to a donation recipient device 126.

In one or more embodiments, whether or not an option to redeem a gift is presented to a user may be determined by a reward offer algorithm 118 of a gifting service system 106. The determination may be triggered via the user device 102 accessing the provider system 104. Additionally or alternatively, the determination may be triggered prior to the access based on a request from the provider system 104 to the gifting service system 106. As an example, the provider system 104 may be associated with a service provider, such as a credit card service provider, and the provider may choose to engage the gifting service system 106 to determine whether the user qualifies as a best customer and, if so, be presented with an option to redeem a gift, which may occur when or before a user accesses the provider system 104 associated with the provider.

The gifting service system 106 may be one or more computing devices such as the computing device 1102 described herein at least in connection with FIG. 11. As an example, the gifting service system 106 may be one or more server computing devices controlled or otherwise used by a gifting service provider (not shown). In one or more embodiments, the gifting service system 106 is configured to provide gifting services, which may be any number of ways to provide users, consumers, businesses, etc. with the ability to offer gifts in a variety of ways for a variety of purposes.

In one or more embodiments, the provider system 104 may provide product information and/or user information to gifting service system 106. In one or more embodiments, the gifting service system 106 includes a provider sub-system 108. The provider sub-system 108 may be one or more computing devices such as the computing device 1102 described herein at least in connection with FIG. 11, or any portion of such computing devices. In one or more embodiments, the provider sub-system 108 includes a datastore (not shown) that stores any data received from or otherwise obtained and related to the provider associated with provider system 104. As such, the provider sub-system 108 may store all or any portion of the product information (described below) received from the provider system 104, all or any portion of any user information (described below) received from the provider system 104 or otherwise obtained by the gifting service system 106.

In one or more embodiments, the product information is stored in a product information store 110 of the provider sub-system 108. The product information store 110 may be one or more computing devices such as the computing device 1102 described herein at least in connection with FIG. 11, or any portion of such computing devices (e.g., data storage for storing one or more data structures that include the product information). In one or more embodiments, the product information store 110 includes a datastore for storing any information related to products associated with the provider system 104, organized in any suitable one or more data structures, that may be offered as gifts to users.

In one or more embodiments, product information, provided from the provider system 104 to the gifting service system 106, may be any information related to any product that may be offered by the provider system 104 as a gift to a user for which a determination was made that the user qualifies to be provided with an option to redeem a gift (e.g., for being a “best customer” of the provider). Such product information may be stored in the product information store 110 of the provider sub-system 108 of the gifting service system 106. The product information may include, for example, names of products, identifiers of products, information about products (e.g., size options, color options, style options, etc.), images of products, etc. As another example, the product information may include categorization information defining what one or more categories of products that a given product of the provider is in. As another example the product information may include product pricing information. As another example, the product information may include identification of products that a provider wants to be offered to a user when a determination is made to present the user with an option to redeem a gift (e.g., for qualifying as a “best customer” of the provider). As another example, the product information may include identification of one or more specific gifts. For example, product information may include information indicating that a specific brand of products should be associated with one or more gift options that may be offered to a user. As another example product information may include information related to inventory levels of one or more products of a provider and/or of one or more gift options that may be offered to a user when a determination is made to provide the user with an opportunity to redeem a gift. Product information may be dynamically updated in real time. As an example, a provider or partner of a provider may provide updated and/or new product information from time to time, which may be used to dynamically update the product information in the product information store 110.

In one or more embodiments, a provider system 104 may be associated with one or more partner systems (not shown). A partner system may be one or more computing devices such as the computing device 1102 described herein at least in connection with FIG. 11. In one or more embodiments, a partner system is associated with a partner of the provider associated with the provider system 104. In one or more embodiments, a partner is any entity that has a relationship with the provider. As an example, a partner may be another provider or other entity that offers products (e.g., goods and/or services). In one or more embodiments, a partner may desire to provide its products as gifts to users identified as best customers relative to the provider system 104. For example, a partner may be seeking to gain customers for its products. To that end, the partner may enter into an agreement with the provider such that the provider will offer one or more products of the partner as gifts when a user qualifies as a best customer of the provider. As an example, the partner may seek to have the provider offer one or more partner products as gifts to users that qualify as best customers within a certain timeframe. As another example, the partner may seek to have the provider offer one or more products of the partner to users that purchase one or more products from the provider and are associated with certain characteristics (e.g., have certain demographic characteristics, spent above a certain amount on the purchase, etc.). In one or more embodiments, in order for one or more partner products to be offered as gifts to users, the partner system may provide product information. Such product information may be provided to the provider system 104. The provider system 104 may, in turn, provide the partner product information to the gifting service system 106 (as described above) as part of the product information provided by the provider system 104. Additionally or alternatively, the partner system may provide the partner product information to the gifting service system 106, and such product information may be stored in the product information store 110.

In one or more embodiments, the provider sub-system 108 includes a user information store 112. The user information store 112 may be one or more computing devices such as the computing device 1102 described herein at least in connection with FIG. 11, or any portion of such computing devices (e.g., data storage for storing one or more data structures that include user information). In one or more embodiments, the user information store 112 includes a datastore for storing any information related to users associated with the provider system 104, organized in any suitable one or more data structures.

User information stored in the user information store 112 may be obtained from the user information received from the provider system 104. Such information may further include any information about users obtained by the gifting service system 106 obtained from any other source for any other purpose. As an example, the gifting service system 106 may have interacted with the user previously (e.g., for redeeming a previous gift, providing gifting services, etc.) and obtained information about the user through the interaction. As another example, user information stored in the user information store 112 may include data related to users obtained via various online sources (e.g., cookies, clickstream data, search data, purchase data, user profile data, etc.), data corresponding to content presented on a website or application (e.g., dates, product details, images, videos, other advertisements, comments, news stories and headlines, etc.), data obtained from e-mails or social media posts/comments/profiles, etc.

In one or more embodiments, user information provided from the provider system 104 to the gifting service system 106 may include information related to the user for which the provider system 104 is seeking a determination as to whether the user qualifies to be provided with an option to redeem a gift (e.g., qualifies as a “best customer”). Such user information may include any information related to or otherwise associated with the user for which such a determination is requested. For example, the consumer may have created an account with the provider, and the provider system 104 may maintain a user profile associated with the user. All or any portion of the information maintained in such a user profile may be provided to the gifting service system 106 as part of the user information. As another example, the provider system 104 may provide information related to any number of users to the gifting service system 106 as user information. User information may include any information about a user such as, for example, demographic information (e.g., name, age, location, etc.), purchase and/or interaction history with the provider, length of time of the relationship between the provider and the user, one or more date ranges of interactions between the user and the provider system 104, etc., which may be obtained by the gifting service system 106 from a provider, and/or sources other than the provider system 104 (e.g., previous interactions with a user, cookies, browser extensions, social media platforms, etc.). User information related to a particular user and/or to one or more groups of users may be referred to as historical user information. In one or more embodiments, historical user information is dynamically updated in real-time. As an example, updates may be added to the historical user information as users make purchases from or otherwise interact with providers, decide whether or not to redeem gifts, make changes to social media profiles, update provider account profiles, etc.

In one or more embodiments, the gifting service system 106 includes a machine learning system 114. The machine learning system 114 may be implemented on one or more computing devices of the gifting service system 106, such as the computing device 1102 described herein at least in connection with FIG. 11, or any portion of such computing devices. Additionally or alternatively, the machine learning system 114 may be implemented as an application or other executable process on one or more computing devices of the gifting service system 106.

The machine learning system 114 may include a reward offer algorithm 118 that is configured to analyze user information stored in the user information store 112 in order to determine whether a user should be provided an offer to redeem a gift (e.g., whether the user qualifies as a “best customer” of the provider). The reward offer algorithm 118 may be implemented on one or more computing devices of the gifting service system 106, such as the computing device 1102 described herein at least in connection with FIG. 11, or any portion of such computing devices. Additionally or alternatively, the reward offer algorithm 118 may be implemented as an application or other executable process on one or more computing devices of the gifting service system 106.

In one or more embodiments, the reward offer algorithm 118 is invoked by the gifting service system 106 in response to receiving or otherwise obtaining or determining a request from the provider system 104 indicating that the provider system seeks a determination as to whether a particular user qualifies to receive an option to redeem a gift (e.g., qualifies as a best customer). Such a request may be made, for example, when the user device 102 accesses the provider system 104. Additionally or alternatively, the request may be made at any other time, such that the provider system is prepared to offer an option to redeem a gift to a qualified user the next time the user device 102 accesses the provider system 104.

The reward offer algorithm 118 may include any number of rules to be evaluated in order to determine whether a user qualifies to receive an offer to redeem a gift. The reward offer algorithm 118 may include rules that associate certain characteristics of a user with a determination as to whether the user qualifies as a best customer (e.g., qualifies to receive an offer to redeem a gift). Examples of such characteristics include, but are not limited to, length of time the user has been associated with the provider system 104, certain actions taken by the user (e.g., paid a bill, spent a certain amount, etc.), user demographic information, date range of an interaction between the user and the provider system 104, a user's interest level in a particular holiday, etc. As an example, the reward offer algorithm 118 may include rules that indicate that a user in a certain geographic region, that has been associated with the provider for more than a certain amount of time, and that has spent a certain amount with the provider over a given period of time qualifies as a best customer and, as such, qualifies to receive an offer to redeem a gift. In one or more embodiments, the above-described rules, and/or any other such rules, may be evaluated by the reward offer algorithm 118 in any combination to determine whether a given user qualifies to be provided with an option to redeem a gift.

In one or more embodiments, the reward offer algorithm 118 may be or include a machine learning model that is trained to determine whether a given user qualifies to receive an offer so receive an option to redeem a gift as a reward (e.g., for being a best customer). Such a machine learning model may use any user information in order to predict whether a given user qualifies to receive an offer to redeem a gift.

As an example, a provider may have a goal of improving user engagement by offering a gift to the best customers of the provider, and is seeking to offer a gift to the best 50,000 customers. To that end, the machine learning model may be trained to predict the likelihood that providing the offer to redeem a gift to a particular user will result in the user maintaining or increasing an engagement level with the provider, and only users with a likelihood over a defined threshold should receive such an offer. The machine learning model may be dynamically updated via continuous training over time to improve its predictive accuracy by adding user information, along with the result of whether the offer resulted in the redeeming of the gift and whether the user maintained or increased engagement with the retailer, to the training data set for the machine learning model, thereby allowing the machine learning model to better predict the likelihood that providing a user with an offer to redeem a gift will result in better engagement by the user with the provider.

Other machine learning techniques may be used as part of the reward offer algorithm 118 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the user information associated with a given user include characteristics similar to other users for which an offer to redeem a gift was made and resulted in the desired outcome of the provider.

In one or more embodiments, using user information, in response to receiving a request from the provider system 104 upon a user accessing the provider system 104, the reward offer algorithm 118 analyzes the user information (as described above) and generates a reward decision. In one or more embodiments, a reward decision is a decision as to whether or not a user should be presented with an offer to redeem a gift (e.g., for qualifying as a best customer of the provider). In one or more embodiments, the gifting service system 106 transmits the reward decision to the provider system 104. Additionally or alternatively, in one or more embodiments, the reward offer algorithm 118 may be invoked, as described above, before user interacts with the provider system 104. In such a scenario, the provider system 104 may be prepared to present the reward to the user at the time the user next accesses the provider system 104. In either scenario, the provider, via the provider system 104, may present a reward notification to the user via the user device 102.

The reward notification may be provided using any suitable technique for alerting the user that the user has received an option to redeem a gift. As an example, while the user is navigating a user interface (e.g., a website, mobile application etc.) of the provider system 104, a user interface element that includes an interactive user interface element (e.g., a button, a link, a quick response (QR) code, etc.) that informs the user that they have been selected to redeem a gift and to interact with the interactive user interface element to begin the redemption process. As another example, the reward notification may be transmitted to the user device 102 using any other suitable communication channel (e.g., email, text message, messaging service, etc.). As another example, the offer to redeem a gift may be presented at a particular point in the interaction between the user an the provider system 104 (e.g., upon completion of a purchase, at a landing page, after payment of a bill, etc.).

In one or more embodiments, the one or more gifts to be offered to the user are determined via a gift options algorithm 116 of the machine learning system 114 of the gifting service system 106. The gift options algorithm 116 may be implemented on one or more computing devices of the gifting service system 106, such as the computing device 1102 described herein at least in connection with FIG. 11, or any portion of such computing devices. Additionally or alternatively, the gift options algorithm 116 may be implemented as an application or other executable process on one or more computing devices of the gifting service system 106. The gift options algorithm 116 may be invoked to determine gift options at the time the decision is made by the reward offer algorithm 118 to provide an offer to redeem a gift to a user, or any time thereafter (e.g., when the user selects to begin a gift redemption process). As used herein, a gift may be any item or service. Examples include, but are not limited to, a physical item, a gift card, a coupon, a service, etc.

In one or more embodiments, the gift options algorithm 116 analyzes user information from the user information store 112 and/or product information from the product information store 110 in order to determine which one or more gift options to provide to the user. As an example, the analysis may include determining that the user is interested in a particular brand, which is associated with one or more provider products and/or partner products that are to be offered as gifts. As another example, the analysis may include determining that the user made a purchase above a certain price, or within a certain price range, and that one or more particular gifts are to be offered with purchases having the price paid by the user. As another example, the analysis may include determining the date on which the user interacted with the provider system 104, and that one or more gift options are to be offered after interactions within a data range that the interaction date is within. As another example, the analysis may include evaluating inventory information to determine what one or more gifts exist in the inventory of the provider or partner of the provider that are to be offered as gifts to users that qualify as best customers of the provider. In one or more embodiments, all or any portion of the aforementioned example analyses may be performed by the gift options algorithm 116 in combination to determine what one or more gift options should be presented to the user.

In one or more embodiments, the gift options algorithm 116 may be or include a machine learning model that is trained to determine what one or more gifts should be presented to the user. As an example, such a machine learning model may use information from product information and/or user information in order to predict what potential gift options are more likely to result on the user electing to redeem a gift. In such a scenario, a provider may have a goal of increasing customer satisfaction with the provider, raising engagement levels, inducing more interaction with the user, etc. To that end, the machine learning model may be trained to predict which one or more particular gifts of the currently available gift options, when presented to the user, are more likely to cause the consumer to decide to redeem the gift.

As an example, the trained gift option machine learning model may be trained to determine that consumers having certain demographic characteristics, living in a certain geographic region, and that made a purchase of a particular brand, and that have been associated with the provider for more than a certain length of time are more likely to select to redeem the gift when a certain type of gift option is presented to the user. The machine learning model may be dynamically updated via continuous training over time to improve its predictive accuracy by adding product information and/or user information, the gift options presented in the offer or other offers for similar users, the results of whether the offer resulted in the redeeming of a gift, the acceptance of the gift by the user, and whether the user redeeming the gift exhibited desired behavior after the redemption, to the training data set for the machine learning model, thereby allowing the machine learning model to better predict gift options that are more likely to result in the redeeming of a gift.

Other machine learning techniques may be used as part of the gift options algorithm 116 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the product information and/or user information associated with or existing at the time of a given user interaction with the provider system 104 had characteristics similar to other users and/or gifts for which an offer to redeem a gift was made and resulted in the outcome(s) desired by the provider.

In one or more embodiments, the user may choose not to redeem a gift by not selecting the interactive element included with the reward notification to begin the process of redeeming the gift, in which case no gift options will be presented to the user, and no gift will be sent to the user. In one or more embodiments, if the user elects to redeem a gift by interacting with the interactive element included with the reward notification (e.g., selecting the button, clicking a text hyperlink, scanning the QR code, etc.), which may be referred to as making a reward redemption request, the gifting service system 106 may provide gift options to the user device 102.

In one or more embodiments, to provide the gift options, the gifting service system may direct the user device to a user interface (i.e., a webpage, mobile application screen, etc.) generated by the gifting service system 106. The user interface may include a presentation of a gift, such as an image, name, description, etc. of the gift. If there is more than one option of what gift may be received, the user interface may include a presentation of the various options via images, names, and/or descriptions of the gifts and a request to select from among the options (e.g., “What gift would you like to receive?”).

The gift options may include any other information without departing from the scope of embodiments described herein. As an example, the gift options may include an image of virtual gift wrapping, and an interactive element that, when selected by the user, reveals (e.g., “unwraps”) the gift. The interactive element may include a signal indicating to the user to select the interactive element to begin the gift redemption process (e.g., “SEE YOUR GIFT”) As another example, the gift options may include explanatory information that provides the user with various details related to the receipt of the gift (e.g., “You have received a gift. To redeem your gift, select the button above, and provide your address to have your gift shipped to you”). As another example, the gift options may include information that provides the user with other details about the gift redemption process (e.g., that the recipient will have the option to exchange the gift for another gift, that the recipient will have the option to select certain customization options related to the gift, etc.).

In one or more embodiments, the one or more gift options presented to the user may depend on when the consumer selects to send a gift (i.e., the timing of the selection to send the gift). As an example, the provider system 104 may transmit the offer to redeem a gift (e.g., the reward notification) in the form of an email. In such a scenario, the user may not immediately open the email, or may open the email but not immediately select to redeem the gift. Thus, the one or more gift options that would be presented to the user may have changed since the time that the reward notification was sent. For example, some or all of the gift options that would have been presented if the user had elected to send a gift near the time that the offer was sent may no longer be available (e.g., there were 1000 partner gifts, but all have already been sent). Therefore, the gift options algorithm 116 may be invoked (possibly again) at the time the user selects to redeem the gift in order to determine gift options that are available at the time of the redemption selection to be presented to the user.

The gift options user interface may also provide various options to the user. Such options may include, but are not limited to, the option to accept the gift offered, or to exchange the gift for another gift from the provider or a partner of the provider. The user interface may include one or more alternate gifts that the user could choose to exchange for the one or more gifts selected by the gift options algorithm 116. The alternate gifts may be presented using an image, a name, and/or details of the one or more alternate gifts.

In one or more embodiments, the user interface presenting the one or more gift options to the user includes an interactive element (e.g., a button, link, etc.) that, when selected (after selecting a gift if more than one is offered), navigates the user to another user interface where additional information is requested from the user. The user interface may include any number of different requests for information from the user. As an example, the page may request that the consumer select a communication channel (e.g., email, text, messenger service, printed mail delivery, etc.) through which the consumer wants to receive information related to the gift. As another example, the page may include a request for a user identifier. The user identifier may include a preferred name of the user, as well as information that facilitates the gifting service system 106 to interact with the user via the user's selected communication channel (e.g., an email address, a phone number, etc.).

The user interface may also include an interactive element that, when selected, allows the user to continue the gift redemption process. The interactive element may change, depending on other selections made by the user. For example, the interactive element may be a button that, when selected by the user, navigates the user to another portion of the user interface to continue the gift redemption process. The interactive element may include a signal indicating to the user to select the interactive element to continue the process. The signal may, for example, be text, which may change based on other selections of the user. As an example, the text may state “Continue” if the recipient checks a check element on the page indicating that they would prefer to continue with the one of the gifts presented in the gift options, but change to “Exchange this gift” if the user checks a check element indicating that they would prefer to exchange the gift for an alternate gift. In one or more embodiments, if the user makes a selection indicating that the user wants to exchange the gift, then the elements on the user interface presenting the one or more alternate gift options may be selectable to allow the user to indicate which alternate gift the user prefers. In such a scenario, the page may also include an indication to the user that the user should select from among the alternate gift options.

In one or more embodiments, the alternate gift options presented to the user are determined by the gift options algorithm 116. As an example, the gift options algorithm 116 may include a predictive machine learning model that takes is provided with the rejection of the gift options, and used to predict the one or more alternate gifts.

In one or more embodiments, once the user has selected a gift, the user may be presented with various customization options (e.g., size, color, etc.) and requests for information (e.g., address to send the gift to, preferred delivery options, etc.). The collective information that includes selected gift, gift customization selections, address, preferred delivery options, preferred communication channel, user identifier, etc. may be referred to as redemption information. The redemption information may be transmitted from the user device 102 to the gifting service system 106.

In one or more embodiments, a user may not want or need a gift provided from the provider for being a best user. In such scenarios, the user interface provided may include one or more additional interactive elements that provide alternate redemption options. Such alternate redemption options may include, for example, an option to donate the value of the gift (e.g., to a charity). In one or more embodiments, a donation process is a process by which a gift recipient (e.g., the user) can select to begin a process for providing the value of the gift to a donation recipient. The provider that provided (and perhaps paid for) the gift may or may not be notified that the user has decided to donate the gift, or be provided any information about an intended donation recipient. In one or more embodiments, the act of the recipient donating the value of a gift counts as a redemption of the gift.

Although the above description contemplates various presentations and user interface portions provided to the recipient to complete the gift redemption process, all or any portion of the presentations may be combined into a single user interface portion, or divided differently into separate user interface portions, without departing from the scope of embodiments described herein. As such, in one or more embodiments, the redemption information may be transmitted to the gifting service system 106 as a single transmission, or as a series of transmissions.

In one or more embodiments, when a user uses an interactive element to indicate a desire to donate the value of a gift to a donation recipient, the indication, which may be referred to as a donation request, is transmitted from the user device 102 to the gifting service system 106. In one or more embodiments, the transmission of the donation request initiates a donation process. In one or more embodiments, the donation process includes the gifting service system 106 requesting various items of information from the user, which may be presented as one or more user interface portions transmitted to the user device 102. Each user interface portion may request all or any portion of the information necessary to donate the value of the gift to a donation recipient. The request for information may be referred to as a donation information request.

In one or more embodiments, the donation information request includes a request from the gifting service system 106 for the user associated with the user device 102 to identify a donation recipient, such as a charity, that will receive the value of the gift as a donation. In one or more embodiments, the user may identify any donation recipient to which the value of the gift will be donated. In one or more embodiments, the user is presented with a set of one or more donation recipient options from among which the user may select a particular donation recipient. In one or more embodiments, the set of one or more donation recipients is determined dynamically in real-time by the gifting service system 106. In one or more embodiments, rather than selecting a single donation recipient, the user may choose to divide the value of the gift among any number of separate donation recipients, with each such donation recipient receiving any portion of the value of the gift.

In one or more embodiments, the set of information provided by the user during the donation process, which may collectively be referred to as donation information, is transmitted from the user device 102 to the gifting service system 106. In one or more embodiments, the gifting service system 106 includes an alternate value calculator 130. The alternate value calculator 130 may be implemented on one or more computing devices, such as the computing device 1102 described herein at least in connection with FIG. 11. Additionally or alternatively, the alternate value calculator 130 may be implemented as an application or other executable process on one or more computing devices of the gifting service system 106.

In one or more embodiments, in response to receiving the donation information, the alternate value calculator 130 determines the value of the gift associated with the gift, which may be the purchase price paid for the gift by the provider associated with the provider system 104. In one or more embodiments, based on the value of the gift, and the donation recipient, the alternate value calculator 130 may determine an alternate value representation. As an example, when the selected donation recipient is a charity that provides meals to socioeconomically disadvantaged children, and the value of the gift is $127, the alternate value calculator may determine that the value of the gift is equivalent to fifty meals to be provided by the charity. Thus the alternate value representation for the gift is 50 meals from the charity. In one or more embodiments, the alternate value representation is transmitted from the gifting service system 106 to the user device 102. The alternate value representation may be presented to the user, and may be accompanied by any amount of additional information, such as the name of the selected donation recipient, an image related to the alternate value, etc. As an example, a page may be presented to the user that indicates that the donation will provide fifty meals from the donation recipient to socioeconomically disadvantaged children, displays the name of the donation recipient, and includes an image of a child enjoying such a meal. The alternate value representation may be provided to the user along with an interactive element (e.g., a button on a webpage) that the user, via the user device 102, may interact with to finalize the donation. The interactive element may include or be accompanied by a signal to the user to indicate that the user should interact with the element to complete the donation process (e.g., text stating “Donate”). Alternatively, alternate value representation may be provided to the user after the donation is complete.

In one or more embodiments, the value of the gift is donated to one or more donation recipients. In one or more embodiments, the gifting service system 106 provides the donation to the donation recipient. The donation may be provided to the recipient via a donation recipient device 126. The donation recipient device 126 may be implemented on one or more computing devices, such as the computing device 1102 described herein at least in connection with FIG. 11. In one or more embodiments, the gifting service system 106 provides the donation information, including the one or more selected donation recipients, to the user via the user device 102 so that the user may perform the donation, and gain any benefits that may be associated with the donation.

In one or more embodiments, all or any portion of any information obtained related to the user and/or the one or more donation recipients is used by the gifting service system 106 to dynamically update historical data maintained by the gifting service system 106, which may be used to dynamically update the machine learning models of the reward offer algorithm 118 and/or the gift options algorithm 116 by adding the obtained information in real-time to the training data sets for the machine learning models.

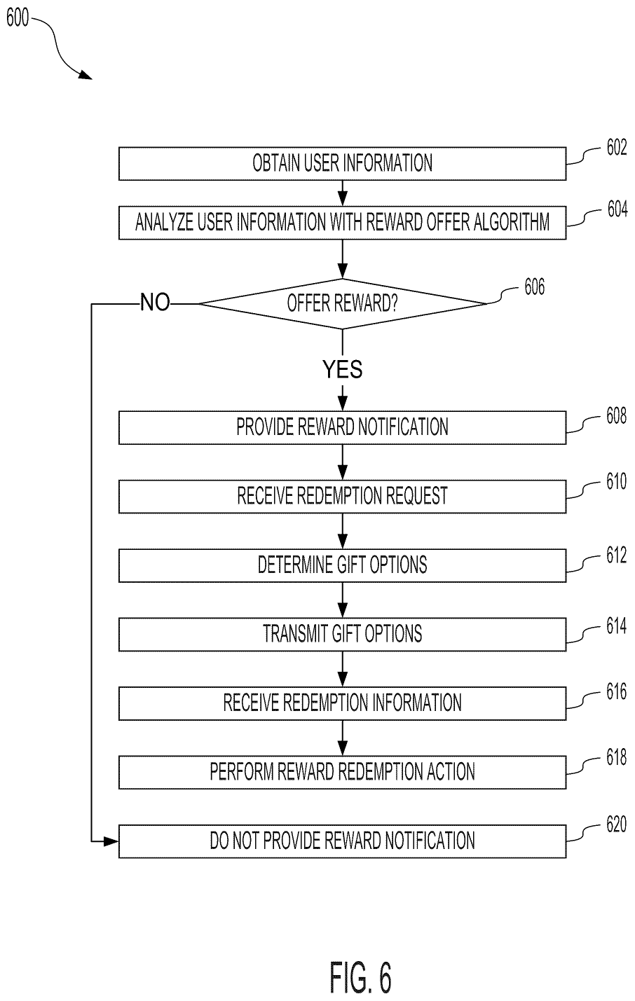

FIG. 6 shows an illustrative example of a process 600 for determining whether to provide a user with an offer to redeem a gift as a result of meeting certain criteria relative to a provider of products (e.g., goods and/or services) in accordance with one or more embodiments described herein. The process 600 may be performed, for example, by a gifting service system, such as the gifting service system 106 described above at least in conjunction with FIG. 1.

At step 602, the process includes obtaining user information. In one or more embodiments, the user information is obtained by a gifting service system. In one or more embodiments, at least a portion of the user information is obtained from a provider system with which a user has a relationship (e.g., the provider provides card services to the user). As an example, such user information may include, but is not limited to, the length of time the user has been a customer of a provider, certain actions taken by the user (e.g., paring a bill, spending a certain amount, etc.), customer demographic information (e.g., region of residence, age, marital status, etc.), information derived from a user profile, data range of an action (e.g., made a purchase over a certain amount in a certain time window), whether or not an external factor exists (e.g., near a holiday), etc. User information may be obtained from other sources without departing from the scope of embodiments described herein, such as, for example, various online sources (e.g., cookies, clickstream data, search data, purchase data, user profile data, etc.), data corresponding to content presented on a website or application (e.g., dates, product details, images, videos, other advertisements, comments, news stories and headlines, etc.), data obtained from e-mails or social media posts/comments/profiles, etc. obtained by the gifting service system. In one or more embodiments, the user information is stored in a user information store (e.g., the user information store 112 of FIG. 1) if the gifting service system.

At step 604, the user information obtained in step 602 is analyzed by a reward offer algorithm (e.g., the reward offer algorithm 118 of FIG. 1) of the gifting service system. As discussed above in the description of FIG. 1, the reward offer algorithm may use the user information as input and evaluate a series of rules to determine whether a user qualifies to receive an offer to redeem a gift (e.g., for being a best customer of the provider). Additionally or alternative, the user information, or any portion thereof, may be provided as input to a trained machine learning model that is trained to output whether a particular user qualifies to receive an offer to redeem a gift. In one or more embodiments, the reward offer algorithm includes a combination of rule evaluation and a trained machine learning model to determine whether a particular user qualifies to receive an offer to redeem a gift.

At step 606, based on the analysis by the reward offer algorithm in step 604, a determination is made as to a user should be provided with an offer to redeem a gist as a reward (e.g., for being a best customer of a provider). In one or more embodiments, of the determination is that the user does not qualify, the process 600 proceeds to step 620. In one or more embodiments, if the determination is that the user does qualify, the process 600 proceeds to step 608.

At step 608, a reward notification is provided to the user. In one or more embodiments, the reward notification is provided to the user by a provider system based on a reward decision received by the provider system from the gifting service system. In one or more embodiments, the reward notification is provided to the user by the gifting service system, as discussed above in the description of FIG. 2. The reward notification may be any suitable form of alerting the user that the user has qualified for a reward. Examples of a reward notification include, but are not limited to, an interactive element displayed on a user interface of the provider system, an email, a text message, a message sent via a messenger service, etc.

At step 610, in response to providing the reward notification in step 608, a redemption request may be received from the user. In one or more embodiments, the redemption request is received at the gifting service system. In one or more embodiments, the redemption request is received as a result of the user interacting with an interactive element provided as part of the reward notification (e.g., click a button, select a link, scan a QR code, etc.).

At step 612, based on receiving the redemption request at step 610, gift options for the user are determined. In one or more embodiments, the gift options are determined by a gift options algorithm (e.g., gift options algorithm 116 of FIG. 1) of the gifting service system, as, for example, discussed above in the description of FIG. 1. In one or more embodiments, the gift options include one or more gifts that may be redeemed, information about the one or more gifts, etc. In one or more embodiments, the gift options also include alternate redemption options such as, for example, a regift option and/or a donation option.

At step 614, the gift options are transmitted. In one or more embodiments, the gift options are transmitted from the gifting service system to the user device associated with the user to whom the reward notification was provided at step 608. As an example, the gift options may be transmitted over a network (e.g., network 1122 of FIG. 11) to the user device.

At step 616, redemption information is received. In one or more embodiments, redemption information is received at the gifting service system from the user device. Redemption information may include any information relating to how a user prefers to redeem a gift. If the user elects to receive a gift, redemption information may include, but is not limited to, a selection of a particular gift, customization options for the selected gift, a user identifier, a communication channel to receive information about the gift, preferred delivery options, delivery address, etc. Redemption information may include a selection of an alternate redemption option. In one or more embodiments, when the alternate redemption option is to regift a gift, the redemption information may include information relating to the intended regift recipient (as discussed above in the description of FIG. 4). In one or more embodiments, when the alternate redemption option is to donate the gift, the redemption information may include information related to the intended donation recipient (as discussed above in the description of FIG. 5).

At step 618. A reward redemption action is performed. Examples of a reward redemption action may include, but are not limited to, delivering a gift to the user, delivering the gift to a regift recipient, donating the value of the gift to a donation recipient, providing information related to the gift redemption process to a provider, and/or updating various machine learning models in real time with information obtained during the gift redemption process.

At step 620, based on a determination in step 606 that the user does not qualify for an offer to be provided with an option to redeem a gift (e.g., because the user does not qualify as a best user of a provider), a reward notification is not provided to the user.

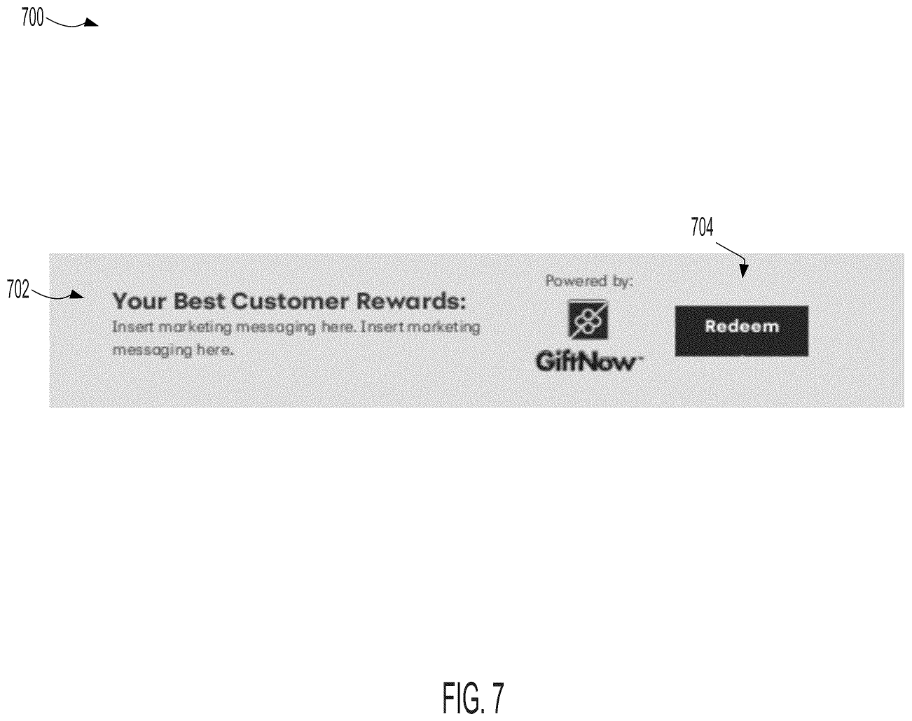

FIGS. 7-10 show illustrative examples of a user receiving an offer to redeem a gift based on a determination that the user qualifies as a best customer of a provider in accordance with one or more embodiments described herein. The following example is for explanatory purposes only and not intended to limit the scope of embodiments described herein. Additionally, while the example shows certain aspects of embodiments described herein, all possible aspects of such embodiments may not be illustrated in this particular example. This example is intended to be a simple example to illustrate, at least in part, concepts described herein.

Referring to FIG. 7, FIG. 7 illustrates an example of a user interface element 700. The user interface element 700 may be presented on a user interface of a provider system (not shown). The user interface element 700 may include a signal 702 that informs a user that the user has qualified as a best customer of the provider associated with the provider system. The user interface element also includes an interactive user interface element 704. The interactive user interface element 704 is a button that, if selected by a user, initiates a gift redemption process.

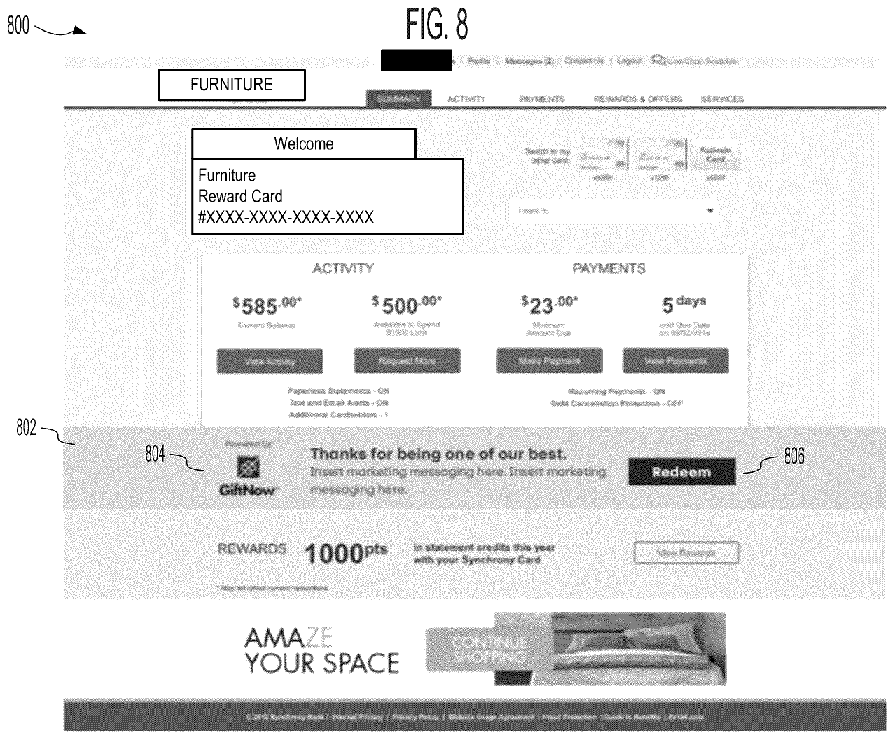

Referring to FIG. 8, FIG. 8 illustrates an example of a user interface 800 in which a user interface element 802 exists that alerts a user of the provider providing the user interface 800 that the user has qualified as a best customer of the provider. The user interface element 802, similar to the user interface element 700 of FIG. 7, includes a signal 804 that informs the user that the user has qualified as a best customer of the provider, and an interactive user interface element 806 within which the user may interact to initiate a gift redemption process.

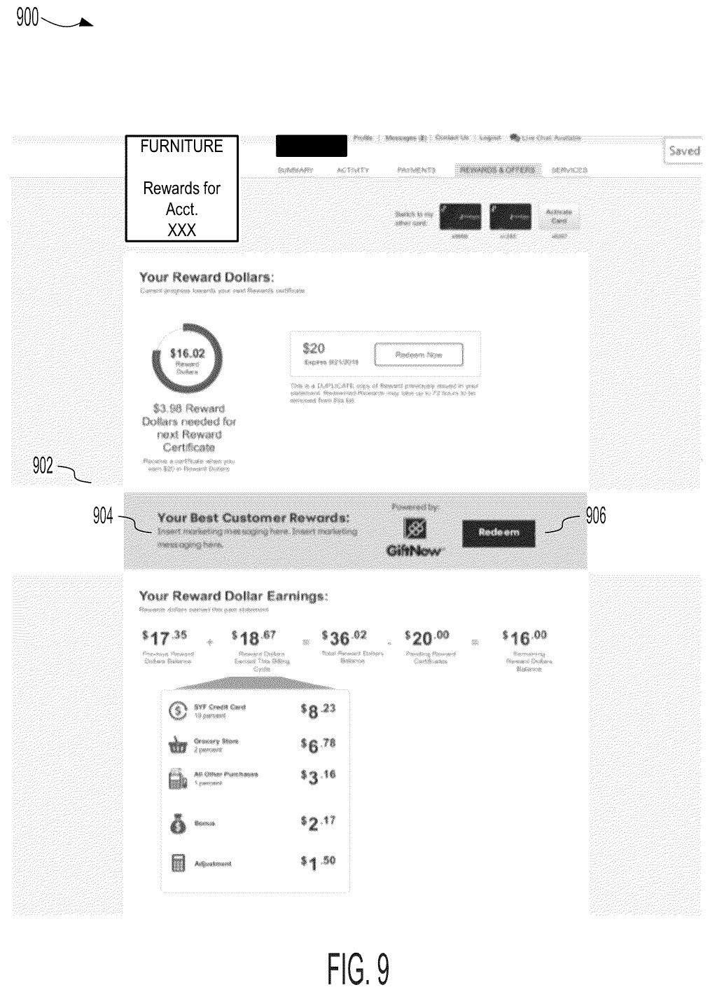

Referring to FIG. 9, FIG. 9 illustrates an additional location with a user interface 900 that a user interface element 902 may exist. The user interface element again includes a signal 904 alerting the user that the user qualifies as a best customer, and an interactive user element 906 that, if interacted with, allows a user to initiate a gift redemption process.

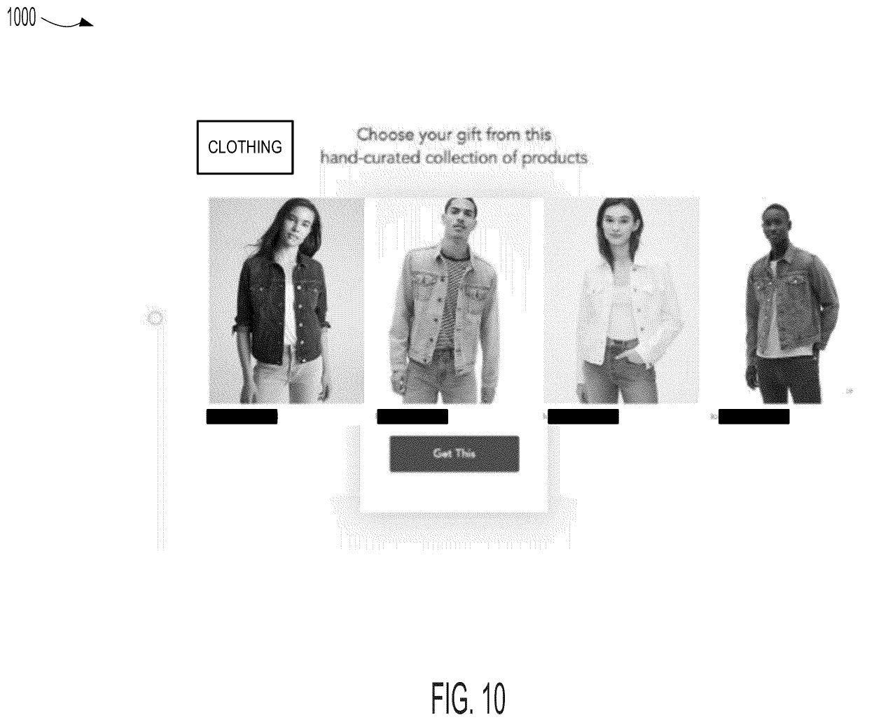

Referring to FIG. 10, FIG. 10 illustrates a user interface 1000 that is provided by a gifting service system after a user interacts with an interactive user interface element to initiate a gift redemption process. Specifically, user interface 1000 displays gift options, with are determined by a gift options algorithm (e.g., gift options algorithm 116 of FIG. 1). In this scenario, user interface 1000 represents the beginning of the gift redemption process which will result in the user receiving a gift, providing a gift to a regift recipient, or donating the value of a gift to a donation recipient.

FIG. 11 illustrates a computing system architecture 1100, including various components in electrical communication with each other, in accordance with some embodiments. The example computing system architecture 1100 illustrated in FIG. 11 includes a computing device 1102, which has various components in electrical communication with each other using a connection 1106, such as a bus, in accordance with some implementations. The example computing system architecture 1100 includes a processor 1104 that is in electrical communication with various system components, using the connection 1106, and including the system memory 1114. In some embodiments, the system memory 1114 includes read-only memory (ROM), random-access memory (RAM), and other such memory technologies including, but not limited to, those described herein. In some embodiments, the example computing system architecture 1100 includes a cache 1108 of high-speed memory connected directly with, in close proximity to, or integrated as part of the processor 1104. The system architecture 1100 can copy data from the memory 1114 and/or the storage device 1110 to the cache 1108 for quick access by the processor 1104. In this way, the cache 1108 can provide a performance boost that decreases or eliminates processor delays in the processor 1104 due to waiting for data. Using modules, methods and services such as those described herein, the processor 1104 can be configured to perform various actions. In some embodiments, the cache 1108 may include multiple types of cache including, for example, level one (L1) and level two (L2) cache. The memory 1114 may be referred to herein as system memory or computer system memory. The memory 1114 may include, at various times, elements of an operating system, one or more applications, data associated with the operating system or the one or more applications, or other such data associated with the computing device 1102.

Other system memory 1114 can be available for use as well. The memory 1114 can include multiple different types of memory with different performance characteristics. The processor 1104 can include any general purpose processor and one or more hardware or software services, such as service 1112 stored in storage device 1110, configured to control the processor 1104 as well as a special-purpose processor where software instructions are incorporated into the actual processor design. The processor 1104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1104 can be a microprocessor, a microcontroller, a digital signal processor (“DSP”), or a combination of these and/or other types of processors. In some embodiments, the processor 1104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1100, an input device 1116 can represent any number of input mechanisms, such as a microphone for speech, a touch-sensitive screen for gesture or graphical input, keyboard, mouse, motion input, pen, and other such input devices. An output device 1118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1100. In some embodiments, the input device 1116 and/or the output device 1118 can be coupled to the computing device 1102 using a remote connection device such as, for example, a communication interface such as the network interface 1120 described herein. In such embodiments, the communication interface can govern and manage the input and output received from the attached input device 1116 and/or output device 1118. As may be contemplated, there is no restriction on operating on any particular hardware arrangement and accordingly the basic features here may be substituted for other hardware, software, or firmware arrangements as they are developed.

In some embodiments, the storage device 1110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 1110 can include hardware and/or software services such as service 1112 that can control or configure the processor 1104 to perform one or more functions including, but not limited to, the methods, processes, functions, systems, and services described herein in various embodiments. In some embodiments, the hardware or software services can be implemented as modules. As illustrated in example computing system architecture 1100, the storage device 1110 can be connected to other parts of the computing device 1102 using the system connection 1106. In an embodiment, a hardware service or hardware module such as service 1112, that performs a function can include a software component stored in a non-transitory computer-readable medium that, in connection with the necessary hardware components, such as the processor 1104, connection 1106, cache 1108, storage device 1110, memory 1114, input device 1116, output device 1118, and so forth, can carry out the functions such as those described herein.

The disclosed gifting service system and the associated systems and methods for providing a consumer with an option to send a gift received as the result of a purchase from a retailer to a separate recipient may be performed using a computing system such as the example computing system illustrated in FIG. 11, using one or more components of the example computing system architecture 1100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems described herein by, for example, executing code using a processor such as processor 1104 wherein the code is stored in memory such as memory 1114 as described herein. One or more of a user device, a provider server or system, a database system, or other such devices, services, or systems may include some or all of the components of the computing system such as the example computing system illustrated in FIG. 11, using one or more components of the example computing system architecture 1100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1104 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1114 can be coupled to the processor 1104 by, for example, a connector such as connector 1106, or a bus. As used herein, a connector or bus such as connector 1106 is a communications system that transfers data between components within the computing device 1102 and may, in some embodiments, be used to transfer data between computing devices. The connector 1106 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1114 can also include magnetic or optical data storage media including read-only (e.g., CD ROM and DVD ROM) or otherwise (e.g., CD or DVD). The memory can be local, remote, or distributed.

As described herein, the connector 1106 (or bus) can also couple the processor 1104 to the storage device 1110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1106 can also couple the processor 1104 to a network interface device such as the network interface 1120. The interface can include one or more of a modem, network interface card (NIC), or other such network interfaces including, but not limited to those described herein. It will be appreciated that the network interface 1120 may be considered to be part of the computing device 1102 or may be separate from the computing device 1102. The network interface 1120 can include one or more of an analog modem, Integrated Services Digital Network (ISDN) modem, cable modem, token ring interface, satellite transmission interface, or other interfaces for coupling a computer system to other computer systems. In some embodiments, the network interface 1120 can include one or more input and/or output (I/O) devices. The I/O devices can include, by way of example but not limitation, input devices such as input device 1116 and/or output devices such as output device 1118. For example, the network interface 1120 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1102 can be connected to one or more additional computing devices such as computing device 1124 via a network 1122 using a connection such as the network interface 1120. In such embodiments, the computing device 1124 may execute one or more services 1126 to perform one or more functions under the control of, or on behalf of, programs and/or services operating on computing device 1102. In some embodiments, a computing device such as computing device 1124 may include one or more of the types of components as described in connection with computing device 1102 including, but not limited to, a processor such as processor 1104, a connection such as connection 1106, a cache such as cache 1108, a storage device such as storage device 1110, memory such as memory 1114, an input device such as input device 1116, and an output device such as output device 1118. In such embodiments, the computing device 1124 can carry out the functions such as those described herein in connection with computing device 1102. In some embodiments, the computing device 1102 can be connected to a plurality of computing devices such as computing device 1124, each of which may also be connected to a plurality of computing devices such as computing device 1124. Such an embodiment may be referred to herein as a distributed computing environment.

The network 1122 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IOT network) or any other such network or combination of networks. Communications via the network 1122 can be wired connections, wireless connections, or combinations thereof. Communications via the network 1122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1122, within the computing device 1102, within the computing device 1124, or within the computing resources provider 1128 can include information, which also may be referred to herein as content. The information may include text, graphics, audio, video, haptics, and/or any other information that can be provided to a user of the computing device such as the computing device 1102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1102 and presented to a user of the computing device 1102 using forms that are perceptible via sight, sound, smell, taste, touch, or other such mechanisms. In some embodiments, communications over the network 1122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1102 and/or the computing device 1124 can be connected to a computing resources provider 1128 via the network 1122 using a network interface such as those described herein (e.g. network interface 1120). In such embodiments, one or more systems (e.g., service 1130 and service 1132) hosted within the computing resources provider 1128 (also referred to herein as within “a computing resources provider environment”) may execute one or more services to perform one or more functions under the control of, or on behalf of, programs and/or services operating on computing device 1102 and/or computing device 1124. Systems such as service 1130 and service 1132 may include one or more computing devices such as those described herein to execute computer code to perform the one or more functions under the control of, or on behalf of, programs and/or services operating on computing device 1102 and/or computing device 1124.

For example, the computing resources provider 1128 may provide a service, operating on service 1130 to store data for the computing device 1102 when, for example, the amount of data that the computing device 1102 attempts to store exceeds the capacity of storage device 1110. In another example, the computing resources provider 1128 may provide a service to first instantiate a virtual machine (VM) on service 1132, use that VM to access the data stored on service 1132, perform one or more operations on that data, and provide a result of those one or more operations to the computing device 1102. Such operations (e.g., data storage and VM instantiation) may be referred to herein as operating “in the cloud,” “within a cloud computing environment,” or “within a hosted virtual machine environment,” and the computing resources provider 1128 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1128 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1130 and service 1132 may implement versions of various services (e.g., the service 1112 or the service 1126) on behalf of, or under the control of, computing device 1102 and/or computing device 1124. Such implemented versions of various services may involve one or more virtualization techniques so that, for example, it may appear to a user of computing device 1102 that the service 1112 is executing on the computing device 1102 when the service is executing on, for example, service 1130. As may also be contemplated, the various services operating within the computing resources provider 1128 environment may be distributed among various systems within the environment as well as partially distributed onto computing device 1124 and/or computing device 1102.

In an embodiment, the computing device 1102 can be connected to one or more additional computing devices and/or services such as merchant computing device 1136 and/or a point-of-sale service 1134 via the network 1122 and using a connection such as the network interface 1120. In an embodiment, the point-of-sale service 1134 is separate from the merchant computing device 1136. In an embodiment, the point-of-sale service 1134 is executing on the merchant computing device 1136. In an embodiment, the point-of-sale service 1134 is executing as one or more services (e.g., the service 1130 and/or the service 1132) operating within the environment of the computing resources provider. As used herein, a point-of-sale service 1134 is a service used by one or more merchants to manage sales transactions for customers, to process payment transactions for customers (e.g., credit card transactions), to manage inventory for merchants, to identify customers based on, for example, customer loyalty programs, and other such tasks.

In an embodiment, a customer and/or a merchant uses the merchant computing device 1136 to interact with the point-of-sale service 1134. In an embodiment, the merchant computing device 1136 is a dedicated point-of-service (POS) terminal. In an embodiment, the merchant computing device 1136 is a cash register system. In an embodiment, the merchant computing device 1136 is an application or web service operating on a computing device such as the computing device 1102 described herein. In such an embodiment, the application or web service may be provided by a financial services system (e.g., a bank, a transaction processing system, an inventory management system, or some other such financial services system). In an embodiment, the merchant computing device 1136 includes an auxiliary device or system to execute tasks associated with the point-of-sale service 1134 (e.g., a credit card processing device attached to a smart phone or tablet). In an embodiment, the merchant computing device 1136 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor or retailer. In an embodiment, the merchant computing device 1136 is a virtual device (e.g., a virtual kiosk) such as the virtual devices described herein. Although not illustrated here, in an embodiment, the merchant computing device 1136 may be one of a plurality of devices that may be interconnected using a network such as the network 1122.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to store data temporarily or permanently. A network interface, such as a wireless or wired interface, can enable the computing device to communicate with a network. Examples of computing devices (e.g., the computing device 1102) include, but are not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1802.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to illustrate embodiments more clearly and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
determining, using a reward offer algorithm, that a user of a provider system is qualified to receive a reward offer;
providing a reward notification to the user based on a determination that the user is qualified to receive the reward offer;
receiving a reward redemption request in response to the reward notification;
analyzing, using a gift options algorithm, user information associated with the user to obtain gift options;
transmitting the gift options;
receiving redemption information in response to the gift options;
performing a reward redemption action using the redemption information; and
dynamically updating the reward offer algorithm based at least in part on the reward redemption action and the redemption information.

2. The computer-implemented method of claim 1, wherein making the determination that the user is qualified to receive the reward offer includes executing the reward offer algorithm using the user information associated with the user obtained in real-time as the user interacts with the provider system.

3. The computer-implemented method of claim 1, wherein making the determination that the user is qualified to receive the reward offer comprises executing the reward offer algorithm using user information associated with the user obtained prior to a particular instance of the user interacting with the provider system.

4. The computer-implemented method of claim 1, wherein the reward notification is an interactive element embedded into a user interface of the provider system that is provided to the user.

5. The computer-implemented method of claim 1, wherein the reward notification is provided to the user via a communication channel separate from the provider system.

6. The computer-implemented method of claim 1, wherein the gift options include a gift from a provider associated with the provider system.

7. The computer-implemented method of claim 1, wherein the gift options include a regift option and the reward redemption action includes providing a gift to a regift recipient.

8. The computer-implemented method of claim 1, wherein the gift options include a donation option and the reward redemption action includes providing a donation to a donation recipient.

9. The computer-implemented method of claim 1, wherein the gift options include a plurality of different gifts.

10. The computer-implemented method of claim 1, wherein the redemption information includes a gift selection and a user identifier.

11. The computer-implemented method of claim 1, wherein the redemption information includes gift customization options.

12. The computer-implemented method of claim 1, wherein the user is an authenticated user of the provider system.

13. The computer-implemented method of claim 1, further comprising, before providing the reward notification to the user:
providing to the user, via the provider system, a reward program update notification.

14. A system, comprising:
one or more processors; and
memory storing thereon instructions that, as a result of being executed by the one or more processors, cause the system to:
determine, using a reward offer algorithm, that a user of a provider system is qualified to receive a reward offer;
provide a reward notification to the user based on a determination that the user is qualified to receive the reward offer;
receive a reward redemption request in response to the reward notification;
analyze, using a gift options algorithm, user information associated with the user to obtain gift options;
transmit the gift options;
receive redemption information in response to the gift options;
perform a reward redemption action using the redemption information; and
dynamically update the reward offer algorithm based at least in part on the reward redemption action and the redemption information.

15. The system of claim 14, wherein making the determination that the user is qualified to receive the reward offer includes executing the reward offer algorithm using the user information associated with the user obtained in real-time as the user interacts with the provider system.

16. The system of claim 14, wherein making the determination that the user is qualified to receive the reward offer comprises executing the reward offer algorithm using user information associated with the user obtained prior to a particular instance of the user interacting with the provider system.

17. The system of claim 14, wherein the reward notification is an interactive element embedded into a user interface of the provider system that is provided to the user.

18. The system of claim 14, wherein the reward notification is provided to the user via a communication channel separate from the provider system.

19. The system of claim 14, wherein the gift options include a gift from a provider associated with the provider system.

20. The system of claim 14, wherein the gift options include a regift option and the reward redemption action includes providing a gift to a regift recipient.

21. The system of claim 14, wherein the gift options include a donation option and the reward redemption action includes providing a donation to a donation recipient.

22. The system of claim 14, wherein the gift options include a plurality of different gifts.

23. The system of claim 14, wherein the redemption information includes a gift selection and a user identifier.

24. The system of claim 14, wherein the redemption information includes gift customization options.

25. The system of claim 14, wherein the user is an authenticated user of the provider system.

26. A non-transitory, computer-readable storage medium storing thereon executable instructions that, as a result of being executed by a computer system, cause the computer system to:
determine, using a reward offer algorithm, that a user of a provider system is qualified to receive a reward offer;
provide a reward notification to the user based on a determination that the user is qualified to receive the reward offer;
receive a reward redemption request in response to the reward notification;
analyze, using a gift options algorithm, user information associated with the user to obtain gift options;
transmit the gift options;
receive redemption information in response to the gift options;
perform a reward redemption action using the redemption information; and
dynamically update the reward offer algorithm based at least in part on the reward redemption action and the redemption information.

27. The non-transitory, computer-readable storage medium of claim 26, wherein the reward notification is an interactive element embedded into a user interface of the provider system that is provided to the user.

28. The non-transitory, computer-readable storage medium of claim 26, wherein the gift options include a gift from a provider associated with the provider system.

29. The non-transitory, computer-readable storage medium of claim 26, wherein the redemption information includes gift customization options.

30. The non-transitory, computer-readable storage medium of claim 26, wherein the user is an authenticated user of the provider system.
